(19) United States
(12) Patent Application Publication
(10) Pub. No.: US 2026/0031903 A1
(43) Pub. Date: Jan. 29, 2026

(54) COMMUNICATION SYSTEM AND NORMALCY JUDGMENT METHOD

(71) Applicant: NIPPON TELEGRAPH AND TELEPHONE CORPORATION, Tokyo (JP)

(72) Inventor: Manabu YOSHINO, Musashino-shi (JP)

(73) Assignee: NIPPON TELEGRAPH AND TELEPHONE CORPORATION, Tokyo (JP)

(21) Appl. No.: 19/099,718

(22) PCT Filed: Aug. 4, 2022
(86) PCT No.: PCT/JP2022/029946

§ 371 Date: Jan. 29, 2025

(51) Int. Cl. H04B 10/073

(52) U.S. Cl. CPC H04B 10/073

(57) ABSTRACT

A communication system includes an instruction device that transmits a loopback instruction for an optical signal; a transceiver device that transmits the optical signal; and a loopback device that loops back the transmitted optical signal to the transceiver device as light based on the loopback instruction. The transceiver device acquires the looped-back optical signal and determines whether a path of the optical signal is normal based on the acquired optical signal. The transceiver device may determine that the path of the optical signal is normal in a case where an attenuation amount of the acquired optical signal is a predetermined attenuation amount. The transceiver device may determine that the path of the optical signal is normal in a case where a time length during which the optical signal is looped back is equal to a predetermined time length.

### TECHNICAL FIELD

The present invention relates to a communication system and a normalcy judgment method.

### BACKGROUND ART

With expansion of the Internet-of-Things (IoT) and progress in digitalization of society and industry, the amount of data traffic flowing on the Internet has become very large. Additionally, service use cases are emerging that are different from best-effort services. As such services advance, there is increasing demand for guaranteed bandwidth and low latency for communication networks. For example, a cyber-physical system requires the following for transport infrastructure: a capacity to enable real-time uploading of a huge amount of sensing data obtained from the real world (physical space) onto an information processing platform (cyber space) without any loss; a capacity to feed back control information to the real world with high reliability and low delay; and a capacity to transmit high-definition images. A cyber-physical system refers a system in which a huge amount of sensing data obtained from the real world is analyzed on a computer, and the analysis results are fed back to achieve optimal control of the real world. It is expected that such cyber-physical systems will provide new values and solutions.

Based on these considerations, all-photonics networks (APNs), which are based on photonics technology, are being considered as a network with a new architecture to accommodate traffic that requires large capacity and low latency (see Non Patent Document 1). APN is one of the transparent networks that transmits any user signals. APN provides an end-to-end optical path, independent of specific communication protocols and optical modulation schemes.

### CITATION LIST

### Non Patent Document

Non Patent Document 1: Shin Kaneko, Kazutaka Hara, Junichi Kani, Takeshi Seki, Hiroki Kawahara, Tadashi Miyamura, Hideki Maeda, “Special Issue 2-10 2. Further Evolution of ICT to Support Super-Smart Society: Novel System Architecture toward the Realization of All-photonics Network”, The Journal of the Institute of Electronics, Information and Communication Engineers, Vol. 104, No. 5, pp. 471-477, May 2021

### SUMMARY OF INVENTION

### Technical Problem

However, a method for determining normality (transmission confirmation) of optical signal paths that transparently transmit main signals of various protocols in APN has not yet been established. Hereinafter, determining normality of an optical signal path will be referred to as “signal path normality determination”. For example, when a communication error occurs, an optical signal transmission path is divided to identify a location where the error has occurred, and signal path normality determination (normality monitoring) is performed for each divided section. In the signal path normality determination for each section, transmission of the optical signal is confirmed from one side to the other, in the target section for signal path normality determination. The transmission confirmation is performed by performing optical-electrical conversion (hereinafter referred to as “OE conversion”) of at least a part of the optical signal at the end point of the target section for signal path normality determination, and then terminating determining, or alternatively, by determining with, for example, nonlinear optical effects regarding the optical signal. Using nonlinear optical effects herein refers to using changes in the gain, the current, or voltage of the gain medium or the light absorption medium, using changes in the passing-through intensities of the pump or gain-clamp lights passed-through the gain medium or the light absorption medium, or using changes in light generated by nonlinear optical effects such as idler lights. For signal path normality determination, a loopback method is mainly used in which a response is looped back, in response to a request from one of the target sections, from the other target section. Loopback of optical signals requires optical-electrical-optical conversion (hereinafter referred to as “OEO conversion”) at a loopback point of a requested optical signal, for which the optical signal is sent to one end point of the target section for optical signal path normality determination or beyond and a response is looped back from the other end point or beyond according to the request.

FIG. 17 is a diagram illustrating examples of a frequency of the control signal and a frequency of the main signal (user signal). In FIG. 17, the control signal is an Auxiliary Management and Control Channel (AMCC) signal. In the APN, a photonic gateway (hereinafter referred to as “Ph-GW”) in a station transmits an AMCC signal whose frequency is superimposed on the main signal to devices constituting a network such as user devices or other Ph-GWs. Devices constituting the network such as user devices or other Ph-GWs may transmit the AMCC signal whose frequency is superimposed on the main signal to other devices constituting the network such as user devices or Ph-GWs. The AMCC signal may be received by devices constituting the network such as user devices or Ph-GWs.

A part of an optical transmission path connected to the Ph-GW, an optical connector provided on the optical transmission path connected to the Ph-GW, or a device connected through the Ph-GW and the optical transmission path is called a user-network interface (UNI) for optical signals. However, when an optical signal is used to monitor the normality of a section of the transmission path (target section), the optical signal is subjected to OE conversion at an end point of the section. Furthermore, when looped back, the optical signal needs to undergo OE conversion and electrical-optical conversion (hereinafter referred to as “EO conversion”) at a loopback point on the opposite side of the section. In other words, if the optical signal remains as it is, there is a problem that normality monitoring cannot be performed unless OE conversion is performed at both ends of the transmission path section.

In view of the circumstances above, an object of the present invention is to provide a communication system and a normality determination method capable of determining normality of an optical signal path without performing OEO conversion at the loopback point of the optical signal.

### Solution to Problem

According to one aspect of the present invention, a communication system includes an instruction device that transmits a loopback instruction for an optical signal; a transceiver device that transmits the optical signal; and a loopback device that loops back the transmitted optical signal to the transceiver device as light based on the loopback instruction, wherein the transceiver device acquires the looped-back optical signal and determines whether a path of the optical signal is normal based on the acquired optical signal.

According to one aspect of the present invention, a normality determination method executed by a communication system includes: transmitting a loopback instruction for an optical signal; transmitting the optical signal; looping back the transmitted optical signal to a transceiver device as light based on the loopback instruction; acquiring the looped-back optical signal; and determining whether a path of the optical signal is normal based on the acquired optical signal.

### Advantageous Effects of Invention

According to the present invention, it is possible to determine the normality of an optical signal path without performing OEO conversion at the loopback point of the optical signal.

### BRIEF DESCRIPTION OF DRAWINGS

FIG. 1 A diagram illustrating a configuration example of a communication system in a first embodiment.

FIG. 2 A diagram illustrating a configuration example of a user device in the first embodiment.

FIG. 3 A flowchart illustrating an example of operations of the communication system in the first embodiment.

FIG. 4 A diagram illustrating a first configuration example of a user device in a modified example of the first embodiment.

FIG. 5 A diagram illustrating a second configuration example of the user device in the modified example of the first embodiment.

FIG. 6 A diagram illustrating a first configuration example of a photonic gateway in a modified example of the first embodiment.

FIG. 7 A diagram illustrating a second configuration example of the photonic gateway in the modified example of the first embodiment.

FIG. 8 A diagram illustrating a third configuration example of the photonic gateway in the modified example of the first embodiment.

FIG. 9 A diagram illustrating a configuration example of a communication system in a second embodiment.

FIG. 10 A diagram illustrating a first example of loopback in the second embodiment.

FIG. 11 A diagram illustrating a second example of loopback in the second embodiment.

FIG. 12 A diagram illustrating a first configuration example of a loopback device in the second embodiment.

FIG. 13 A diagram illustrating a second configuration example of the loopback device in the second embodiment.

FIG. 14 A diagram illustrating a third configuration example of the loopback device in the second embodiment.

FIG. 15 A diagram illustrating a configuration example of a loopback device in a modified example of the second embodiment.

FIG. 16 A diagram illustrating a hardware configuration example of the communication system according to an embodiment.

FIG. 17 A diagram illustrating examples of a frequency of a control signal and a frequency of a main signal.

### DESCRIPTION OF EMBODIMENTS

### Communication Network as Comparative Example Against APN

An architecture of a communication network as a comparative example is configured to connect access, metropolitan, and core networks in a hierarchical manner. When traffic is transferred from the access network to the metropolitan network across a boundary therebetween, optical signals are temporarily converted to electrical signals at the boundary. Similarly, when traffic is transferred from the metropolitan network to the access network across a boundary therebetween, optical signals are temporarily converted to electrical signals at the boundary. Further, in the communication network as a comparative example, broader bandwidth optical signals (optical paths) are aggregated and multiplexed in order to deal with a larger number of users and services.

In such a communication network, economic performance can be achieved by sharing devices between users and services. On the other hand, a path bandwidth per user and service is restricted. Therefore, data compression processing is required when transmitting a large amount of data such as high-definition images, resulting in large delays. Furthermore, aggregation and multiplexing of electrical signals causes delays and jitter due to packet or frame waiting processing.

### Basic Configuration Example of APN

Meanwhile, since the APN employs a flat architecture, there is no need for the electrical termination of optical signals that is provided between layers in the communication network as a comparative example against APN. The APN has very low delay due to end-to-end optical path connections. Furthermore, the APN has high flexibility and expandability in that it can easily provide a large-capacity, low-latency communication network for each function without depending on a specific communication protocol.

The APN includes two types of optical nodes: photonic gateway (Ph-GW) and photonic exchange (hereinafter referred to as “Ph-EX”), which minimize electrical processing such as exchange, multiplexing, and switching. The Ph-GW has full mesh connectivity. The Ph-GW is an optical node located at the entrance of the full mesh network and accommodates various user devices. The full mesh connectivity is a connection in which each element constituting the communication network is connected directly to every other element in the network. The Ph-EX is an optical node that provides a huge number of optical paths. The vast number of optical paths transparently traverses the optical backbone network.

With such a configuration, it is possible to directly connect installation points of any user devices by optical signals without performing electrical processing in the APN. By allocating dedicated wavelengths to users and services, it becomes possible to implement large-capacity, low-latency communication. The APN enables a variety of services by means of flexible combinations of necessary service function processing at points in need. Further, the APN is capable of providing a communication environment where users can enjoy services regardless of service types, protocols, optical wavelengths, or other factors.

In order to implement end-to-end direct optical connection and service function processing at points in need, the Ph-GW has the five basic functions illustrated below.

A first basic function is to determine which wavelength a user device adopts and to remotely set wavelength information on the user device. For opening an end-to-end optical path, the Ph-GW is required to have a function of allocating a wavelength to each optical path so that the wavelengths of optical signals do not overlap between optical paths sharing a transmission medium (for example, optical fiber) within the APN. Further, the Ph-GW is required to have a function of remotely setting wavelength information of the optical signal for the user device corresponding to an end point of the optical path.

A second basic function is to stop unnecessary signals caused by incorrect settings of the wavelength information in the user device by communicating optical signals between an access network-side port and a full mesh network-side port when the optical path is open. Herein, the access network is a network between the Ph-GWs and the user device, and the full mesh network is a network among the Ph-GWs or the Ph-GWs and the Ph-EXs. The Ph-GW transfers (cross-connects) optical signals depending on the destination: optical signals input from the access network to the access network; optical signals input from the access network to the full mesh network; optical signals input from the full mesh network to the access network; and optical signals input from the full mesh network to the full mesh network.

A third basic function is to aggregate and disaggregate optical paths sharing the same transmission medium within the full mesh network.

A fourth basic function is a turn-back function for directly optically connecting user devices accommodated in the same Ph-GW. By enabling turn-back at the Ph-GW located at the entrance of the full mesh network, rather than turn-back at an upper optical node, direct optical connection is achieved via the shortest path.

A fifth basic function is for extraction and insertion. This function enables electrical processing at the Ph-GW location, thereby performing regenerative repeating of optical signals in terms of optical signal transmission, as well as, service function processing.

### Overview

In the communication system of the embodiment, the loopback processing of the optical signal transmitted from the Ph-GW does not include OEO conversion for the optical signal, and thus the optical signal is looped back to the Ph-GW as light. The communication system includes the Ph-GW as an optical signal transceiver device on one side (station side) of a target section for normality determination. Further, the communication system includes a user device or a loopback device near the other target section. The target section is, for example, any of all the sections between user devices. Since sections are further divided to test the normality, the target section may be between the user device and the Ph-GW, between the Ph-GWs, or between the user devices. The user device and Ph-GW are illustrated as devices at the ends of the section in the drawings.

In a case where the user network interface (UNI) is located immediately in front of the user device, corresponding to “Loop 2” of “ISDN Basic User-Network Interface: Layer 1 Specification”, Telecommunication Technology Committee (TTC) Standard JT-1430, a loopback point is a location near the user network interface (UNI).

The user device or the loopback device (loopback point) loops back the optical signal transmitted from the Ph-GW as light to the Ph-GW without performing OEO conversion on the optical signal. The user device or the loopback device loops back the optical signal as light via a switching unit that switches reflection or transmission of the optical signal in response to a loopback instruction from the Ph-GW. As the Ph-GW receives the looped-back optical signal, it is possible to determine (confirm) the normality of a path from the vicinity of the user device or the loopback device to the Ph-GW.

Alternatively, the Ph-GW loops back the optical signal transmitted from the user device, the loopback device or the other Ph-GW as light to the user device, the loopback device or the other Ph-GW without performing OEO conversion on the optical signal. The Ph-GW loops back the optical signal as light via a switching unit or a loopback unit, which switches reflection or transmission of the optical signal, according to instructions either by itself or by the other Ph-GW. As the user device, the loopback device or the other Ph-GW receives the looped-back optical signal, it is possible to determine (confirm) the normality of a path from the Ph-GW to the user device, the loopback device or the other Ph-GW. It should be noted that paths may be different as long as paths are configured between a device transmitting the optical signal and a device receiving the optical signal.

Accordingly, the OEO conversion is not required at the loopback point. Both the EO conversion and the OE conversion may be performed on the opposite side of the loopback point. That is, light transmission (EO conversion) and light reception (OE) conversion are essential at any end point or a location connected to the end point, thus they may be performed.

A method of switching between reflection and transmission of the optical signal transmitted from the Ph-GW is not limited to a specific method. For example, a reflection-transmission unit may switch between reflection and transmission of the optical signal (whether loopback is turned on or off) using Fresnel reflection at an end point of an optical fiber connected to the reflection-transmission unit, in which Fresnel reflection is caused by inserting/extracting the optical fiber.

A functional unit that inputs light into a section, extracts the input light, and determines (confirms) normality is not limited to being installed in the Ph-GW, but may be installed in the user device. Further, the Ph-GW or user device on the opposite side may be provided with a loopback point. An access network management control unit of the Ph-GW may determine the normality of a path through which the optical signal has traveled back and forth based on either attenuation according to a transmission distance of the optical signal or whether a reflection time length is equal to a predetermined time length. The access network management control unit of the Ph-GW may determine the normality of the path through which the optical signal has traveled back and forth based on any of the followings: whether the intensity of the optical signal changes depending on whether the input optical signal is turned on or off; whether the polarization changes depending on the polarization modulation of the input optical signal; whether the intensity of the optical signal changes depending on whether it is turned on or off depending on the switching between reflection and transmission of the optical signal at the loopback point; whether the polarization changes depending on the polarization modulation of the optical signal at the loopback point; and the other modulation situations. Changes in response to intensity modulation, polarization modulation or other modulations are changes with a time delay in response to propagation delays.

In a case where the reflectance varies depending on the wavelength, the access network management control unit of the Ph-GW may determine the normality of the path through which the optical signal has traveled back and forth, according to the wavelength sweep of the optical signal transmitted from Ph-GW, based on whether the intensity of the optical signal received by the Ph-GW changes. This corresponds to adding a modulation element regarding wavelength on the loopback side regarding intensity. If polarization-dependent reflection is performed on the optical signal, something similar to what is possible with wavelength is possible with polarization.

Embodiments of the present invention will be described in detail with reference to the accompanying drawings.

### First Embodiment

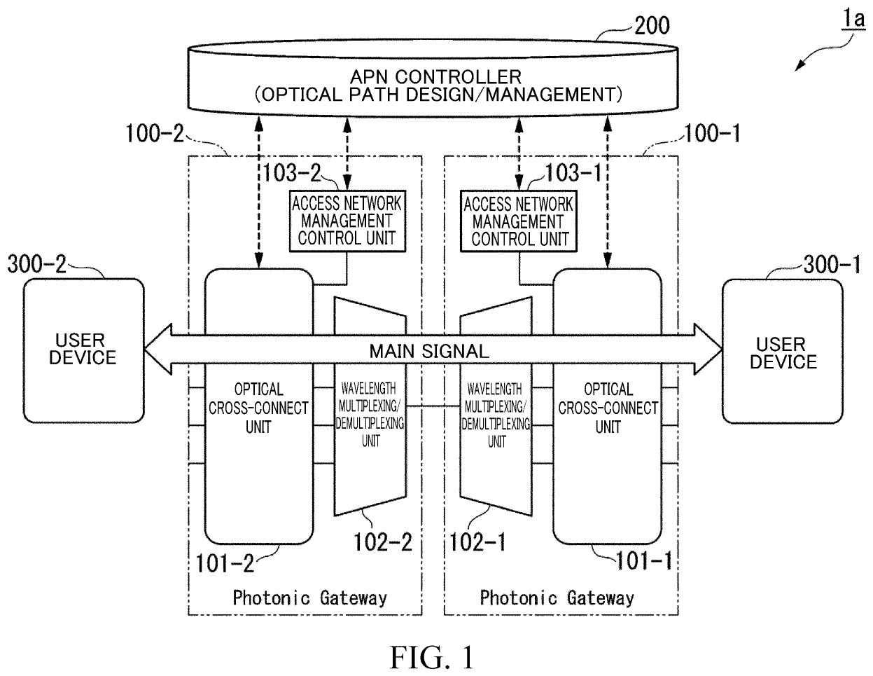

FIG. 1 is a diagram illustrating a configuration example of a communication system 1a according to a first embodiment. The communication system 1a is a communication system that communicates using a communication network such as an all-photonics network (APN). The communication system 1a determines the normality of an optical signal path without performing OEO conversion.

The communication system 1a includes a Ph-GW 100-1, a Ph-GW 100-2, an APN controller 200, a user device 300-1, and a user device 300-2. For better understanding, two Ph-GWs and two user devices are shown in FIG. 1. In the actual communication system, it is assumed that, for example, a large number of Ph-GWs and user devices are arranged, the Ph-EX may be interposed between Ph-GWs, and user devices are interposed only through a single Ph-GW.

The Ph-GW 100 transmits and receives optical signals in order to determine the normality of sections divided for the user device and the other Ph-GW 100 sections and to monitor and control the user device, so it has a device (transceiver device) that transmits and receives optical signals. Note that if a location of the Ph-GW 100 is not at an end point of the section, the optical signal may be transmitted.

The Ph-GW 100 is a device (cross-connect device) that cross-connects optical signals to destinations. The Ph-GW 100-1 includes an optical cross-connect unit 101-1, a wavelength multiplexing/demultiplexing unit 102-1, and an access network management control unit 103-1. The Ph-GW 100-2 includes an optical cross-connect unit 101-2, a wavelength multiplexing/demultiplexing unit 102-1, and an access network management control unit 103-2. The optical cross-connect unit 101 includes a plurality of input/output ports (not shown). It should be noted that the wavelength multiplexing/demultiplexing unit 102 does not need to be provided on the path of the target optical signal.

A user device 300-1 includes an optical transceiver 301-1 (optical TRx) (not shown). A user device 300-2 includes an optical transceiver 301-2 (optical TRx) (not shown).

The optical cross-connect unit 101-1 and the optical cross-connect unit 101-2 transfer (cross-connect) optical signals input from the access network and the full mesh network as light according to the destination. Thereby, the optical cross-connect unit 101-1 and the optical cross-connect unit 101-2 implement a loopback function (the fourth basic function described above) for direct optical connection.

The optical cross-connect unit 101-1 and the optical cross-connect unit 101-2 implement a loopback function (the fourth basic function described above) for direct optical connection of the user devices 300 accommodated in the same Ph-GW 100. Furthermore, the optical cross-connect unit 101-1 and the optical cross-connect unit 101-2 implement optical add-drop (the fifth basic function described above) to an electrical processing unit (not shown).

When a loopback signal is transmitted and received by the access network management control unit 103-2 of the Ph-GW 100-2, for example, the normality of a path connecting the access network management control unit 103-2, the optical cross-connect unit 101-2, the user device 300-2, the optical cross-connect unit 101-2 and the access network management control unit 103-2 is determined.

When the loopback signal is transmitted and received by the access network management control unit 103-2 of the Ph-GW 100-2, for example, the normality of the following paths may be determined: a transmission path connecting the access network management control unit 103-2, the optical cross-connect unit 101-2, a loopback unit (not shown) or a reflection-transmission unit (not shown) on the left side of the optical cross-connect unit 101-2, the optical cross-connect unit 101-2, the wavelength multiplexing/demultiplexing unit 102-2, and the gateway; and a transmission path connecting the wavelength multiplexing/demultiplexing unit 102-1, the optical cross-connect unit 101-1, the user device 300-1, the optical cross-connect unit 101-1, the wavelength multiplexing/demultiplexing unit 102-1, the wavelength multiplexing/demultiplexing unit 102-2, the loopback unit (not shown) or the reflection-transmission unit (not shown) on the left side of the optical cross-connect unit 101-2, the wavelength multiplexing/demultiplexing unit 102-2, and the access network management control unit 103-2.

When the loopback signal is transmitted and received by the access network management control unit 103-2 of the Ph-GW 100-2, for example, the normality of the following paths may be determined: a transmission path connecting the access network management control unit 103-2, the optical cross-connect unit 101-2, the loopback unit (not shown) or the reflection-transmission unit (not shown) on the left side of the optical cross-connect unit 101-2, the optical cross-connect unit 101-2, the wavelength multiplexing/demultiplexing unit 102-2, and the gateway; a transmission path connecting the wavelength multiplexing/demultiplexing unit 102-1, the optical cross-connect unit 101-1, a loopback unit (not shown) or a reflection-transmission unit (not shown) on the right side of the optical cross-connect unit 101-1, the optical cross-connect unit 101-1, the wavelength multiplexing/demultiplexing unit 102-1, and the gateway; and a path connecting the wavelength multiplexing/demultiplexing unit 102-2, the optical cross-connect unit 101-2, the loopback unit (not shown) or the reflection-transmission unit (not shown) on the left side of the optical cross-connect unit 101-2, the optical cross-connect unit 101-2, and the access network management control unit 103-2.

When a loopback signal is transmitted and received by the access network management control unit 103-1 of the Ph-GW 100-1, for example, the normality of a path connecting the access network management control unit 103-1, the optical cross-connect unit 101-1, the user device 300-1, the optical cross-connect unit 101-1 and the access network management control unit 103-1 is determined.

When the loopback signal is transmitted and received by the access network management control unit 103-1 of the Ph-GW 100-1, for example, the normality of the following paths may be determined: a transmission path connecting the access network management control unit 103-1, the optical cross-connect unit 101-1, the loopback unit (not shown) or the reflection-transmission unit (not shown) on the left side of the optical cross-connect unit 101-1, the optical cross-connect unit 101-1, the wavelength multiplexing/demultiplexing unit 102-1, and the gateway; and a transmission path connecting the wavelength multiplexing/demultiplexing unit 102-2, the optical cross-connect unit 101-2, the user device 300-2, the optical cross-connect unit 101-2, the wavelength multiplexing/demultiplexing unit 102-2, the wavelength multiplexing/demultiplexing unit 102-1, the loopback unit (not shown) or the reflection-transmission unit (not shown) on the left side of the optical cross-connect unit 101-1, the wavelength multiplexing/demultiplexing unit 102-1, and the access network management control unit 103-1.

When the loopback signal is transmitted and received by the access network management control unit 103-1 of the Ph-GW 100-1, for example, the normality of the following paths may be determined: a transmission path connecting the access network management control unit 103-1, the optical cross-connect unit 101-1, the loopback unit (not shown) or the reflection-transmission unit (not shown) on the left side of the optical cross-connect unit 101-1, the optical cross-connect unit 101-1, the wavelength multiplexing/demultiplexing unit 102-1, and the gateway; a transmission path connecting the wavelength multiplexing/demultiplexing unit 102-2, the optical cross-connect unit 101-2, a loopback unit (not shown) or a reflection-transmission unit (not shown) on the right side of the optical cross-connect unit 101-2, the optical cross-connect unit 101-2, the wavelength multiplexing/demultiplexing unit 102-2, and the gateway; and a path connecting the wavelength multiplexing/demultiplexing unit 102-1, the optical cross-connect unit 101-1, the loopback unit (not shown) or the reflection-transmission unit (not shown) on the left side of the optical cross-connect unit 101-1, the optical cross-connect unit 101-1, and the access network management control unit 103-1.

The wavelength multiplexing/demultiplexing unit 102-1 wavelength-multiplexes optical signals that share the same path among the optical signals output from the optical cross-connect unit 101-1. The wavelength multiplexing/demultiplexing unit 102-1 outputs the wavelength-multiplexed optical signal to the full mesh network.

The wavelength multiplexing/demultiplexing unit 102-1 demultiplexes the wavelength multiplexed signal input from the full mesh network in units of wavelengths. The wavelength multiplexing/demultiplexing unit 102-2 wavelength-multiplexes optical signals that share the same path among the optical signals output from the optical cross-connect unit 101-2.

The wavelength multiplexing/demultiplexing unit 102-2 outputs the wavelength-multiplexed optical signal to the full mesh network. The wavelength multiplexing/demultiplexing unit 102-2 demultiplexes the wavelength multiplexed signal input from the full mesh network in units of wavelengths (the third basic function described above).

The Ph-GW 100 is one of the devices (transceiver devices) provided in the Ph-GW 100 to transmit and receive optical signals. The access network management control unit 103-1 exchanges control information between the access network management control unit 103-1 and the user device 300-1 at the time of initial connection of the user device 300-1. The access network management control unit 103-1 transmits a wavelength setting instruction to the user device 300-1.

The access network management control unit 103-2 exchanges control information between the access network management control unit 103-2 and the user device 300-2 at the time of initial connection of the user device 300-2. The access network management control unit 103-2 transmits a wavelength setting instruction to the user device 300-2 (the first basic function described above).

Instead of multiplexing the access system optical signal with the optical signal that is the main signal by space division multiplexing, polarization division multiplexing or wavelength division multiplexing, the access network management control unit 103 may multiplex the control signal with the optical signal that is the main signal by time-division multiplexing, code-division multiplexing or frequency-division multiplexing such as AMCC, or alternatively, may modulate the control signal into the optical signal that is the main signal by intensity modulation, phase modulation, frequency modulation or polarization modulation. In this case, instead of multiplexing using an optical coupler/splitter or multiplexer/demultiplexer, multiplexing may be performed using a modulator, or alternatively, an amplifier or attenuator that can modulate an amplification factor or attenuation factor. In the description of this application, a case where the control signal is multiplexed on the optical signal of the main signal will be mainly explained, however it is apparent that this method can be also adopted when multiplexing an access optical signal other than the optical signal that is the main signal. In a case where the access optical signal is multiplexed on the loopback side and an optical transmitter and an optical receiver for the access optical signal and the main signal are separate, since the optical transmitter and the optical receiver for the main signal do not need the normality determination, it is desirable to loop back between the optical transmitter and the optical receiver or to determine normality by means other than loopback. By using these methods, if the loopback signal is looped back from the optical transmitter of the access system optical signal only when the normality of the optical transmitter and the optical receiver of the main signal is determined, it is possible to notify the normality of the optical transmitter and the optical receiver for the main signal with a single loopback. Of course, the normality of the optical transmitter and the optical receiver for the main signal, and the normality of the optical transmitter and the optical receiver for the access system optical signal may be determined and notified separately.

APNs that support various social infrastructure networks are required to be able to set up optical paths for various user devices so that dedicated networks with wavelengths for different functions can be easily provided. Therefore, a mechanism is required in which an optical path is immediately open by connecting the user device 300-1 and the user device 300-2 to the optical fiber.

First, the user device 300-1 or the user device 300-2 reports its own device information and opposing device information to the nearest Ph-GW, for example. The user device 300-1 or the user device 300-2 may report its own device information and opposing device information to the Ph-GW 100-1 or the Ph-GW 100-2.

Although the reporting is made to the nearest Ph-GW 100, the reporting may be made to the Ph-GW 100 other than the nearest one. For example, the user device 300-1 or the user device 300-2 may report its own device information and opposing device information to the Ph-GW 100-2 or the Ph-GW 100-1. The latter is suitable in a case where, for example, when restoring a connection, the information on the PhGW to which the opposite device is connected is known. The following description will mainly describe the case where the reporting is made to the nearest one.

Second, an APN controller 200 performs wavelength resource management and optical path design within the APN. In response to the report from the user device 300-1 or the user device 300-2, the Ph-GW 100-1 or Ph-GW 100-2, in cooperation with the APN controller 200, determines the allocated wavelength for the user device 300-1 or the user device 300-2. The Ph-GW 100-1 or the Ph-GW 100-2 notifies the user device 300-1 or the user device 300-2 of its wavelength.

Third, an internal path for the Ph-GW 100-1, an internal path for the Ph-GW 100-2, and an internal path for the Ph-EX are set respectively. In FIG. 1, the internal path for the Ph-GW 100-1, the internal path for the Ph-GW 100-2, and a path connecting the Ph-GW 100-1 and the Ph-GW 100-2 are set. In a case where the Ph-GW100-1 and the Ph-GW100-2 are connected via the Ph-EX (not shown), the following paths are set: an internal path for the Ph-GW 100-1, a path for the Ph-GW 100-1 and the Ph-EX (not shown), an internal path for the Ph-EX (not shown), a path for the Ph-EX (not shown) and the Ph-GW 100-2, and an internal path for the Ph-GW 100-2.

In the APN, optical signals according to signals of various communication protocols are transmitted from the user device 300-1 and the user device 300-2. Therefore, a management control method that does not depend on communication protocols is required. For example, AMCC is used for such access system control management.

In the communication system la, the user device 300-1 communicates via the Ph-GW 100 within the station. When a communication error occurs, the Ph-GW 100 executes a signal path normality determination (transmission confirmation) for each predetermined section on the path of the communication system 1a.

The figure shows an example in which one device is a Ph-GW and the other device is a user device. Depending on the section and direction for determining normality, one device may be a user device and the other device may be a Ph-GW, or both devices may be user devices or Ph-GWs.

As a determination procedure, (B1) indicates that one device is a Ph-GW and the other device is a user device, and (B2) indicates that one device is a user device and the other device is a Ph-GW. The same applies to other sections. (B1) The optical cross-connect unit and others are set so that the access system control unit and the user device can communicate. The access system control unit instructs the user device to loop back the main signal (the instruction may be a control signal or a main signal). The access system control unit generates and transmits a downstream signal for normality determination. As long as a device (for example, access system control unit) can receive and determine the looped-back signal, it is allowable to generate an instruction using any main signal protocol instead of using the main signal protocol of the user device. When determining by receiving only the control signal from the looped-back optical signal, the instruction may be generated using any main signal protocol, or alternatively the optical signal may be unmodulated light as long as it can carry a control signal, without generating an instruction using a protocol that the access system control unit cannot determine (main signal protocol of the user device). If the main signal and the control signal are those in which different lights (e.g. lights of different wavelengths) are superimposed, only the optical signal for the control signal may be used (it should be noted that if no instruction is given by the control signal, the main signal does not need to be modulated by the control signal, and the control signal does not need to be superimposed on the main signal). The user device loops back the downstream signal or a signal obtained by modulating the signal as an upstream signal (it should be noted that if no response is given by the control signal, the main signal does not need to be modulated by the control signal, and the control signal does not need to be superimposed on the main signal). The access system control unit receives and terminates the looped-back upstream signal and determines the signal. Based on the time elapse or an instruction from the access control unit (the instruction may be a control signal or a main signal), the loopback of the signal of the user device is canceled.

When receiving the control signal, some of the signals may be terminated without being looped back, or loopback may be interrupted at predetermined time intervals and control signal reception may be performed.

(B2) The optical cross-connect unit and others are set so that the access system control unit and the user device can communicate. The access system control unit instructs the user device to generate and transmit an upstream signal for normality determination (the instruction may be a control signal or a main signal). The user device generates and transmits the upstream signal for normality determination (it should be noted that if no response is given by the control signal, the main signal does not need to be modulated by the control signal, and the control signal does not need to be superimposed on the main signal). The access system control unit loops back and transmits the upstream signal or a signal obtained by modulating the signal as a downstream signal. As long as a device (for example, user device) can receive and determine the looped-back signal, it is allowable to generate an instruction using any main signal protocol instead of using the main signal protocol of the user device. When determining by receiving only the control signal from the looped-back optical signal, the instruction may be generated using any main signal protocol, or alternatively the optical signal may be unmodulated light as long as it can carry a control signal, without generating an instruction using a protocol that the user device cannot determine (main signal protocol of the user device). If the main signal and control signal are superimposed with different light (for example, light of different wavelengths), only the optical signal for the control signal may be used (it should be noted that if no instruction is given by the control signal, the main signal may be modulated by the control signal, and the control signal does not need to be superimposed on the main signal). The user device receives and terminates the looped-back downstream signal and determines the signal. Based on the time elapse or an instruction from the access control unit (the instruction may be a control signal or a main signal), the generation and transmission of the signal for normality determination of the user device is canceled, and the determination result is acquired from the user device (a control signal or a main signal may be used for acquisition).

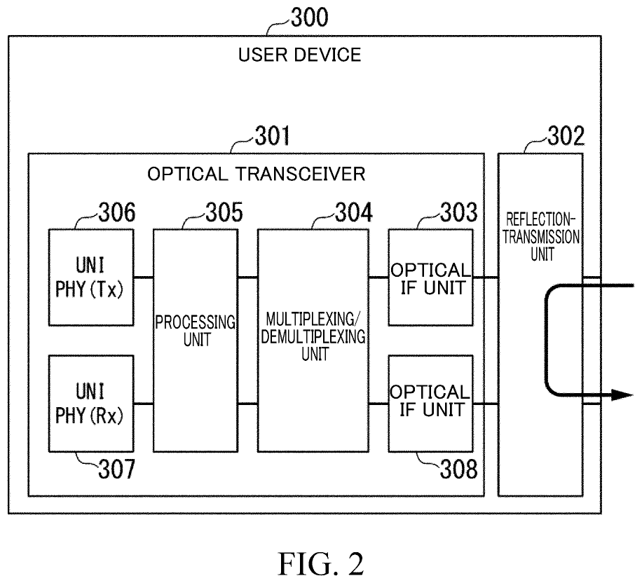

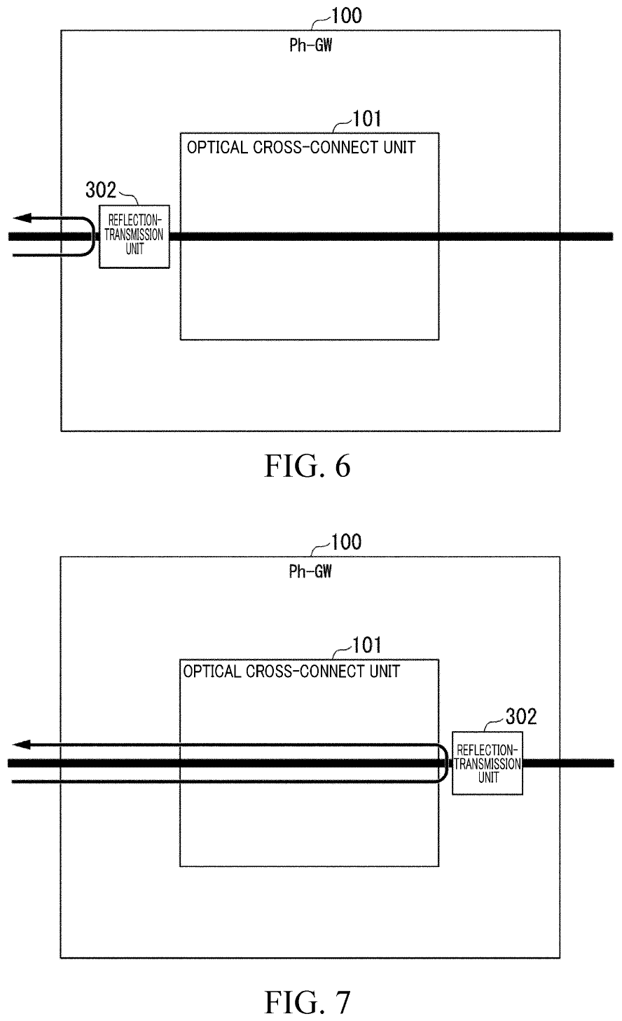

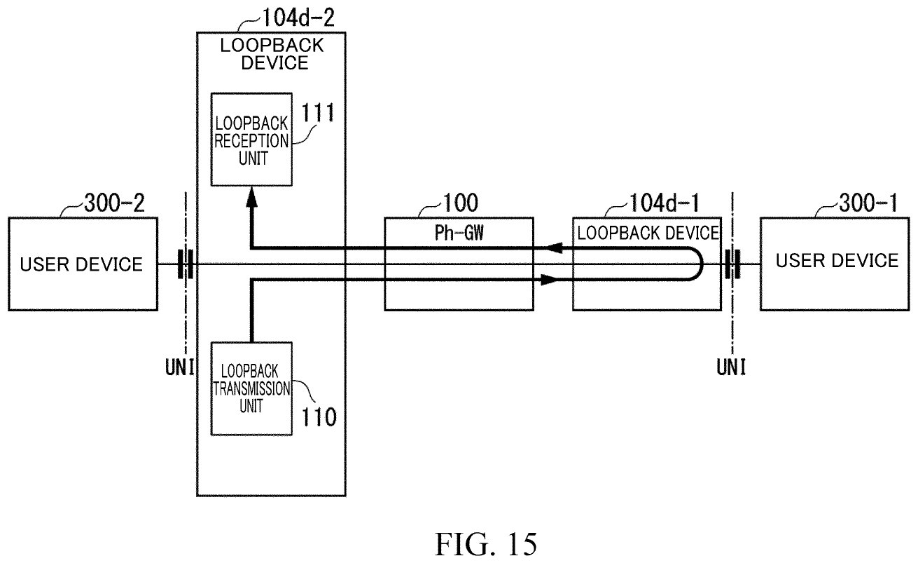

When receiving the control signal, some of the signals may be terminated without being looped back, or loopback may be interrupted at predetermined time intervals and control signal reception may be performed. Herein, when connecting the user device and the access network management control unit, the connection is switched by the optical cross-connect unit, and the user device and the access network management control unit are connected. Instead, for example, the “monitoring unit 60” in FIG. 2, the “monitoring unit 65” in FIG. 6, the “monitoring unit 60” in FIG. 15, and configurations respectively illustrated in FIGS. 33 to 36 and FIGS. 67 to 69, of Reference 1 (WO 2022/091392), may be used to connect the user device and the access network management control unit. These structures are similarly adopted in embodiments to be described later.

The main signal is generated and terminated by the access system control unit, or is looped back in the embodiment above. However, the main signal may be generated and terminated by the access system control unit, or it may not be looped back; and the access system control unit may generate, terminate, or loop back the main signal only when the main signal that is modulated by the control signal or superimposed with the control signal cannot be obtained from a section opposite to the target section for normality determination. In a case where the Ph-GW does not receive the main signal that should be the downstream signal, particularly, in a case where one device is the Ph-GW and the other device is the user device, when performing normality determination with a device opposite to the user device that loops back the control signal, e.g. the other user device, using main signals from other Ph-GWs and user devices, or alternatively, when main signals from other Ph-GWs and user devices are used, and then the signal light continues to be passed with the device opposite to the user device that loops back the control signal, for example, the other user device, whereby only the superimposed control signals are extracted (using a wavelength filter if the wavelengths are different) and terminated; only part of the split signal light is terminated; or light that is affected by nonlinear optical effects of at least the control signal in the signal light to receive at least the control signal is terminated but the main signal is transmitted, communication can be maintained using the main signal to continue even during normality determination. If one device is a user device and the other device is a Ph-GW, without generating and/or terminating the main signal that is modulated with the looped-back control signal or superimposed with the looped-back control signal, the main signal from the device on the opposite side of the target section for normality determination, for example, the other Ph-GW or user device may be used, and a termination section of this embodiment may be used only when the main signal is not available. When performing normality determination with a device opposite to the user device that loops back the control signal, e.g. the other user device, using main signals from other Ph-GWs and user devices, or alternatively, when main signals from other Ph-GWs and user devices are used, and then the optical signal continues to be passed with a device opposite to the user device that generates and terminates the control signal, for example, the other user device, whereby only the superimposed control signals are extracted, or light to which at least the control signal of the optical signal is transferred due to part of the split signal light or nonlinear optical effects is terminated, communication can be maintained using the main signal to continue even during normality determination.

In these cases, the control signal is used for determination, so determination is available even when the main signal does not correspond to the protocol of the user device or is unmodulated light (continuous wave [CW] light). In practice, this corresponds to the case of inserting light for modulation with the control signal. When superimposing a control signal from a separate light source independent of the main signal, there is no need to insert a main signal that does not correspond to the protocol of the use device or is unmodulated light (CW light), unless there is a reason, for example, gains of amplifiers in the path should be aligned.

In the communication system la, a path between the opposing user devices 300 is divided by the Ph-GW 100-1 and the Ph-GW 100-2. In order for the Ph-GW 100 to loop back light, the reflection-transmission unit 302 illustrated in FIG. 2 may be included in the Ph-GW 100. The Ph-GW 100 may loop back the light using a loopback function (basic function) for direct optical connection. The reflection-transmission unit 302 is suitable for a single-core bidirectional communication mode, and the loopback function is suitable for a dual-fiber bidirectional communication mode. Additionally, the control unit may instruct the user device to make a determination based on the transmission and reception of the optical signal for normality determination, and the light may be looped back using the loopback function for direct connection of the optical signal in the Ph-GW100. The reflection-transmission unit 302 or the opposing user device 300 may loop back the light. In this case, communication between the access network management control unit 103 of the Ph-GW 100 and the user device 300 is cut off when the normality is determined. Thus the user device determines the normality, and after communication is restored, the access network management control unit 103 acquires the normality determination result. The Ph-GW 100-1 transmits a signal requesting loopback of the optical signal (loopback instruction) to the user device 300-1. The Ph-GW 100-1 receives a response to the signal requesting loopback from the user device 300-1. The Ph-GW 100-1 determines the normality of a signal path between the Ph-GW 100-1 and the user device 300-1 based on the received response.

Similarly, the Ph-GW 100-2 transmits a signal requesting loopback of the optical signal (loopback instruction) to the user device 300-2. The Ph-GW 100-2 receives a response to the signal requesting loopback from the user device 300-2. The Ph-GW 100-1 determines the normality of a signal path between the Ph-GW 100-2 and the user device 300-2 based on the received response.

Similarly, the Ph-GW 100-1 transmits a signal requesting loopback of the optical signal (loopback instruction) to the Ph-GW 100-2. The Ph-GW 100-1 receives a response to the signal requesting loopback from the Ph-GW 100-2. The Ph-GW 100-1 determines the normality of a signal path between the Ph-GW 100-1 and the Ph-GW 100-2 based on the received response.

The method of signal path normality determination is not limited to a specific determination method (test method). The access network management control unit 103 may determine the path normality based on either attenuation according to a transmission distance of the optical signal (whether the attenuation amount of the looped-back optical signal is a predetermined attenuation amount) or whether a reflection time length is equal to a predetermined time length (whether a time length during which the optical signal is looped back is equal to the predetermined time length).

The access network management control unit 103 may determine the path normality based on either: whether the intensity of the optical signal varies when loopback is turned on or off (whether the intensity of the looped-back optical signal varies at a timing corresponding to the loopback instruction (after the times of propagation delay and device response delay have elapsed after the instruction)); or whether the optical signal subjected to polarization modulation according to the modulation is received at the timing according to the modulation instruction (after the times of propagation delay and device response delay have elapsed after the instruction) (whether the polarization rotation amount of the looped-back optical signal is a predetermined rotation amount).

In a case where the reflectance varies depending on the wavelength, the access network management control unit 103 may determine the path normality according to the wavelength sweep of the optical signal transmitted from the Ph-GW 100, based on whether the intensity of the optical signal received by the Ph-GW 100 changes. That is, the access network management control unit 103 may determine the path normality based on whether the intensity of the optical signal received by the Ph-GW 100 changes for each wavelength according to the reflectance per wavelength of the optical signal.

The access network management control unit 103 may determine the path normality using the AMCC signal of the APN. The access network management control unit 103 may determine the path normality using “Ethernet (registered trademark) Operation Administration Maintenance (OAM)”. The access network management control unit 103 may determine the path normality using a control channel of a lower header whose payload is a main signal (user signal). As the control channel, for example, a general communication channel (GCC) of an optical transport network (OTN) may be used to determine the path normality. For example, the user device 300-2 and the Ph-GW 100-2 may perform determination based on the intensity of the optical signal, the user device 300-1 and the Ph-GW 100-1 may perform determination based on the intensity of the optical signal, the determination may be performed based on the AMCC signal, and the Ph-GW 100-1 and the Ph-GW 100-2 may perform determination using a general-purpose communication channel of the optical transport network (OTN). The AMCC signal may be erased or overwritten. However, a process in which the optical signal is subjected to OE conversion, a process in which change is added to the converted electrical signal, and a process in which the changed electrical signal is subjected to EO conversion are not necessary.

FIG. 2 is a diagram illustrating a configuration example of the user device 300 in the first embodiment. The user device 300 (loopback device) includes an optical interface unit 303 (optical IF unit), a multiplexing/demultiplexing unit 304, a processing unit 305, a UNI_PHY (Tx) 306, a UNI_PHY (Rx) 307, an optical interface unit 308 (optical IF unit), and a reflection-transmission unit 302. The user device 300 includes the reflection-transmission unit 302 on the side of the user device 300 that is closer to the APN (Ph-GW). The user device 300 may include the reflection-transmission unit 302 in the optical IF unit.

The reflection-transmission unit 302 switches operation modes in response to a loopback instruction from the access network management control unit 103. If there is no instruction from the access network management control unit 103 (instruction device) to loop back the optical signal, the reflection-transmission unit 302 transmits the optical signal (user signal) sent from the Ph-GW 100 and outputs to the optical interface unit 303.

When instructed by the access network management control unit 103 to loop back the optical signal, the reflection-transmission unit 302 loops back the optical signal transmitted from the Ph-GW 100 or the opposing user device to the Ph-GW 100 as a loopback signal and as light, without performing OE conversion, according to a period during which normality is determined. That is, the reflection-transmission unit 302 performs loopback of all channels. In other words, the reflection-transmission unit 302 (loopback point) loops back the loopback signal to the Ph-GW 100 (transceiver device) without changing any bit in a bit sequence of the received loopback signal. Namely, the reflection-transmission unit 302 reflects the optical signal transmitted from the Ph-GW 100. In FIG. 2, an arrow returning to the network side from the network side via the reflection-transmission unit 302 represents the loopback of the optical signal.

Loopback of the optical signal without modulation is the closest to full-channel loopback of the three loopback mechanisms for maintenance of “Layer 1” in the “JT-1430 Standard”. The three loopback mechanisms include (1) full-channel loopback, (2) partial loopback, and (3) logical loopback. In full-channel loopback, the optical signal is looped back to a transmitting station with all bit sequences unchanged. There are several points that differ from “Layer 1” of the “JT-1430 Standard” in that the optical signal is looped back without modulation.

First, the loopback point is not at a position close to a reference point “T” within “NT1” but at a far position. Therefore, it does not correspond to “Loop 2”.

Furthermore, since there are signals (analog signals) that are not treated as bit sequences in the APN, in such a case, the communication device cannot send back the bit sequence. However, even if the bit sequence cannot be sent back, this point (difference) can be ignored as long as the information is sent back as is.

Furthermore, if a wavelength-dependent element and a polarization-dependent element have different reflectance, the optical signal will not be sent back without modulation. Adding modulation, amplification or attenuation to a part of the optical signal in at least one of the time domain and the frequency domain and looping back the optical signal can be understood as falling under a category of either “(2) partial loopback” or “(3) logical loopback”. In the partial loopback, the received bit sequence of at least one designated channel is sent back to the transmitting station unchanged. Therefore, if the modulation frequency is regarded as a channel, partial modulation and loopback of the optical signal are similar to the partial loopback. This is because there may be certain changes in the looped-back information. Further, the modulation and loopback of the optical signal are similar the logical loopback.

Note that each of the three loopback mechanisms is further classified into (a) transparent loopback and (b) non-transparent loopback. This is a classification for signals that are transmitted beyond the loopback point without being looped back. Accordingly, it is possible to achieve “(a) transparent loopback” and “(b) non-transparent loopback” by reflecting a part of the optical signal and transmitting the remaining optical signal. In the “(a) transparent loopback”, the signal transmitted beyond the loopback point (forward signal) and the received signal at the loopback point are the same. In the “(b) non-transparent loopback”, the signal transmitted beyond the loopback point (forward signal) and the received signal at the loopback point are the same. However, it is mainly assumed that the optical signal will not be transmitted. The received signal may be amplified, or modulation (on-off modulation, intensity modulation or polarization modulation) performed on the light as is may be executed on the received signal.

The optical interface unit 303 (optical IF unit) converts the optical signal transmitted through the reflection-transmission unit 302 into an electrical signal. In this way, OE conversion may be performed inside the user device 300. The optical signal transmitted through the reflection-transmission unit 302 may be an optical signal that is the main signal (user signal) or an optical signal that is the loopback signal. The optical interface unit 303 outputs an electrical signal corresponding to the optical signal transmitted through the reflection-transmission unit 302 to the multiplexing/demultiplexing unit 304. Even when OE conversion is performed, the remaining optical signal excluding the portion to be OE-converted is not subjected to OEO conversion and is looped back. In the normal loopback, signals from users are not transmitted to the network side during loopback. Further, signals from the network are not transmitted to the user side. Therefore, the following description that signals from the user device are transmitted to the network and signals from the network are transmitted to the user side is about the operation in the case of no loopback. Depending on the method of loopback, a half mirror, for example, may be used to transmit the signals even during loopback.

The multiplexing/demultiplexing unit 304 demultiplexes the main signal (user signal) and the control signal in the optical signal output from the optical interface unit 303. The multiplexing/demultiplexing unit 304 outputs the main signal in the optical signal output from the optical interface unit 303 to the processing unit 305.

The multiplexing/demultiplexing unit 304 multiplexes the control signal onto the main signal (user signal) in the electrical signal output from the processing unit 305. For example, if the control signal is an AMCC signal, the multiplexing/demultiplexing unit 304 frequency-superimposes the control signal on the main signal. The multiplexing/demultiplexing unit 304 outputs the electrical signal including the main signal and the control signal to the optical interface unit 308.

A configuration shown below in which the user device includes a MAC as the processing unit is a mere example, and the user device does not need to include the MAC.

The processing unit 323 is, for example, a regenerative repeater, and includes a reshaping function, a retiming function, and a regenerating function. For example, a multiplexing unit and a demultiplexing unit are provided. For example, provided is a conversion unit that converts a signal from a user NW into a signal format transmitted by the APN. For example, provided is a framer that demultiplexes signals from the user NW into transmission frames. The processing unit 323 is, for example, the MAC, and executes media access control. For example, the MAC may perform such media access control when transmitting and receiving user signals that define and allocate addresses (MAC addresses) for identifying devices. For example, the MAC may control the transmission timing of optical signals. The MAC performs media access control on the optical signal output from the multiplexing/demultiplexing unit 304. The MAC receives signals from the user, sends signals to the user, receives signals from the network, and sends signals to the network in accordance with media access control. During loopback, the process of not allowing the user device to communicate signals from the user device to the network side and from the network side to the user side may be performed using media access control. The MAC may execute media access control so that a signal from the UNI_PHY (Tx) 306 is not output from the network side to the user side, and a signal from the UNI_PHY (Rx) 307 is not output from the user side to the network side.

Note that the configurations of the multiplexing/demultiplexing unit and the processing unit do not need to be limited to those described above. For example, the multiplexing/demultiplexing unit may be placed closer to the network than the optical IF unit and the optical IF unit. In this case, the multiplexing/demultiplexing unit performs AMCC superimposition and demultiplexing on the optical signal. Furthermore, when control signals are exchanged using OTN frames or GCC, the multiplexing/demultiplexing unit and the processing unit may function as OTN framers.

The UNI_PHY (Tx) 306 is a reception function unit in a physical layer of the user network interface. The UNI_PHY (Rx) 307 performs predetermined reception processing on the electrical signal (main signal) output from the processing unit 305. A receiver (Rx) on the user side receives signals from the user side, and a receiver (Rx) on the network side receives signals from the network side.

The UNI_PHY (Rx) 307 is a transmission function unit in the physical layer of the user network interface. The UNI_PHY (Tx) 306 outputs the electrical signal according to the main signal (user signal) to the processing unit 305 by executing predetermined transmission processing. A transmitter (Tx) on the user side transmits a signal to the user side. A transmitter (Tx) on the network side transmits a signal to the network side.

The optical interface unit 308 (optical IF unit) on the transmission side converts the electrical signal output from the multiplexing/demultiplexing unit 304 into an optical signal. In this way, processing of converting an electrical signal into an optical signal may be executed inside the optical transceiver 301. The optical interface unit 308 outputs the converted optical signal to the reflection-transmission unit 302. The optical interface unit 308 on the reception side converts the optical signal into the electrical signal. If the optical signal is not looped back, the optical interface unit performs OE conversion or EO conversion. If the reflection-transmission unit 302 does not transmit the optical signal, the optical interface unit performs OE conversion or EO conversion during loopback. If the optical signal from the network is looped back, part there is split and received, and some of the optical signals are multiplexed on the looped-back optical signal, the optical interface unit performs OE conversion or EO conversion during loopback. The UNI_PHY (Rx) 307 receives a signal from the user side. The received signal is output to the network side via the device. The received signal may be terminated within the device. The UNI_PHY (Tx) 306 outputs a signal from the network side or a signal from inside the device to the user side. The UNI_PHY (Rx) 307 side of the optical interface unit receives a signal from the network. The received signal is output to the user side via the device. The received signal may be terminated within the device. The UNI_PHY (Tx) 306 side of the optical interface unit outputs a signal from the user side or a signal from inside the device to the network side. Note that the receiver (Rx) on the user side and the receiver (Rx) on the network side are not shown.

Next, an operation example of the communication system 1a will be described.

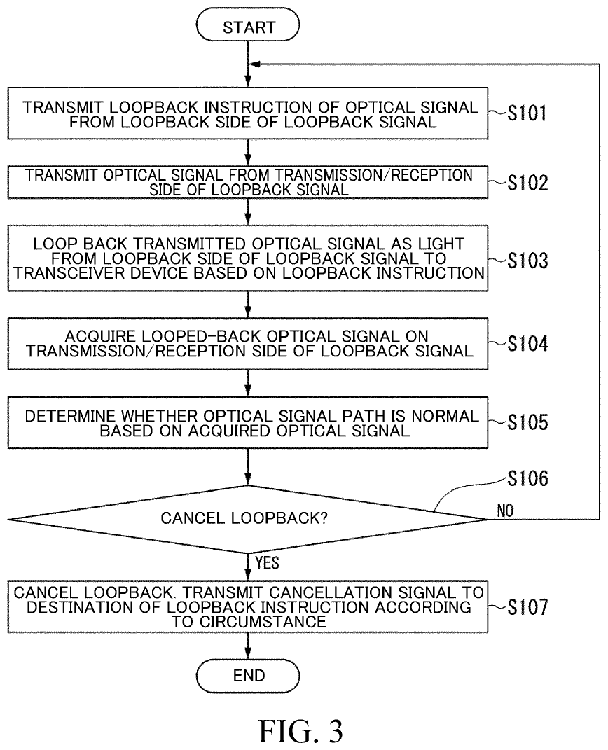

FIG. 3 is a flowchart for describing an example of the operation of the communication system 1a in the first embodiment. The optical cross-connect unit 101-2 of the Ph-GW 100-2 transmits an optical signal loopback instruction to the user device 300-1 (step S101). The optical cross-connect unit 101-2 of the Ph-GW 100-2 transmits an optical signal to the user device 300-2. A transmission device that transmits the optical signal that is looped back by the opposing device for normality determination may be the optical cross-connect unit 101 equipped with such function, or may be the opposing user device 300, or may be the access network management control unit 103 as illustrated in FIG. 1.

When a transmitter that transmits the optical signal that is looped back by the opposing device for normality determination is placed in the Ph-GW, the transmitter may be provided at a position other than the access network management control unit connected via the optical cross-connect unit. For example, the transmitter may be placed in a position where it can output the optical signal to the loopback device through the optical coupler/splitter or optical multiplexer/demultiplexer installed outside the input port or output port of the optical cross-connect unit. For example, the transmitter may be placed in the monitoring unit that monitors the optical intensity of the optical signal on at least one of the input side and output side of the Ph-GW and exchanges control signals with the user device. Instead of outputting combined or multiplexed light through the optical coupler/splitter or the optical multiplexer/demultiplexer, light generated may be output by optical nonlinear effects of the light to be looped back.

When a receiver that receives at least a part of the optical signal that is looped back by the opposing device for normality determination is placed in the Ph-GW, the receiver may be provided at a position other than the access network management control unit connected via the optical cross-connect unit. For example, the receiver may be placed at a position where it can input at least a part of the optical signal or its components looped back from the loopback device through the optical coupler/splitter the optical multiplexer/demultiplexer installed outside the input port or output port to the optical cross-connect unit. For example, the receiver may be placed in the monitoring unit that monitors the optical intensity of the optical signal on at least one of the input side and output side of the Ph-GW and exchanges control signals with the user device. Instead of inputting split or demultiplexed light through the optical coupler/splitter or the optical multiplexer/demultiplexer, light generated may be input by optical nonlinear effects of the looped-back light.

The optical signal that is looped back in the opposite direction for normality determination is transmitted by the optical cross-connect unit itself that is equipped with such a function, by the opposing user device (described later), or by the access network management control unit 103 in the case shown in FIG. 1, or alternatively, by a device (not shown) via a monitor circuit (not shown) connected before and after an cross-connect device (not shown) used for the entrance setting or exit setting of the Ph-GW 100. In the case of the access network management control unit 103, the connection of the optical cross-connect unit is changed, and instead of connecting to the wavelength multiplexing/demultiplexing unit, it is connected to the access network management control unit 103.

The access network management control unit 103 makes a determination based on the acquired optical signal when the access network management control unit 103 receives an optical signal. When the optical cross-connect unit receives an optical signal, it transmits the reception result to the access network management control unit 103. The result is transmitted to the access network management control unit 103 from the opposing user device when the opposing user device receives the optical signal, and from the monitor device when the monitor circuit (not shown) connected before and after the optical cross-connect device (not shown) used for the entrance setting or exit setting of the Ph-GW 100 receives the optical signal.

In a case where the transmission device that transmits the optical signal that is looped back by the opposing device for normality determination is the access network management control unit 103, the connection of the optical cross-connect unit 101 is changed, and instead of the optical cross-connect unit 101 being connected to the wavelength multiplexing/demultiplexing unit 102, the optical cross-connect unit 101 is connected to the access network management control unit 103. The user device 300-1 may transmit the optical signal to the user device 300-2 (step S102). Based on the loopback instruction, the user device 300-2 loops back the transmitted optical signal to the Ph-GW 100-1 as light (step S103). The optical cross-connect unit 101-2 of the Ph-GW 100-2 acquires the looped-back optical signal (step S104). The access network management control unit 103-2 determines whether an optical signal path is normal based on the acquired optical signal (step S105). In a case where the access network management control unit 103 receives the optical signal, the access network management control unit 103 makes a determination based on the acquired optical signal. When the optical cross-connect unit 101 receives the optical signal, the optical cross-connect unit 101 transmits the reception result to the access network management control unit 103. When the opposing user device 300 receives the optical signal, such a user device 300 transmits the result to the access network management control unit 103. The result is transmitted to the access network management control unit 103 from a monitor device (not shown) when the monitor circuit (not shown) connected before and after the optical cross-connect device (not shown) used for the entrance setting or exit setting of the Ph-GW 100 receives the optical signal.

The user device 300 determines whether to cancel loopback. The loopback may be canceled when a predetermined time has elapsed (for example, when a counter value of a timer reaches a predetermined value), or the loopback may be canceled when an optical signal of a predetermined wavelength and a predetermined intensity is received (step S106). If the loopback is not canceled (step S106: NO), the user device 300 returns the process to step S101. If the loopback is canceled (step S106: YES), the user device 300 transmits a cancellation signal to the Ph-GW 100 that sent the loopback instruction (step S107). Note that the case where the process returns to step S101 after executing step S106 is the case where the loopback setting on the loopback side is automatically canceled based on, for example, the counter value of the timer. If the loopback setting is explicitly canceled based on, for example, instructions, there is no need to execute step S106.

As described above, the Ph-GW 100-2 (instruction device) (transceiver device) transmits an optical signal loopback instruction to the user device 300-2. When the user device 300-2 loops back the optical signal, the Ph-GW 100-1 may transmit and receive the optical signal. The Ph-GW 100-2 (transceiver device) or the user device 300-1 transmits the optical signal to the user device 300-2. In this way, the instruction device and the transceiver device may be integrated. The user device 300-2 (loopback device) loops back the transmitted optical signal to the Ph-GW 100-2 (transceiver device) based on the loopback instruction. The Ph-GW 100-2 acquires the looped-back optical signal. The Ph-GW 100-2 determines whether the optical signal path is normal based on the acquired optical signal.

The same applies between the user device 300-1 and the Ph-GW 100-1. Further, the same applies between the Ph-GW 100-1 and the Ph-GW 100-2.

In this way, the user device (loopback device) loops back the optical signal transmitted from the Ph-GW to the Ph-GW as light. Accordingly, it is possible to determine the normality of an optical signal path without performing OEO conversion at the loopback point of the optical signal.

### Modified Example of First Embodiment

Main differences from the first embodiment in the modified example of the first embodiment include that the user device transmits an optical signal to the Ph-GW, and the Ph-GW loops back the optical signal as light. The modified example of the first embodiment will be described focusing on differences from the first embodiment.

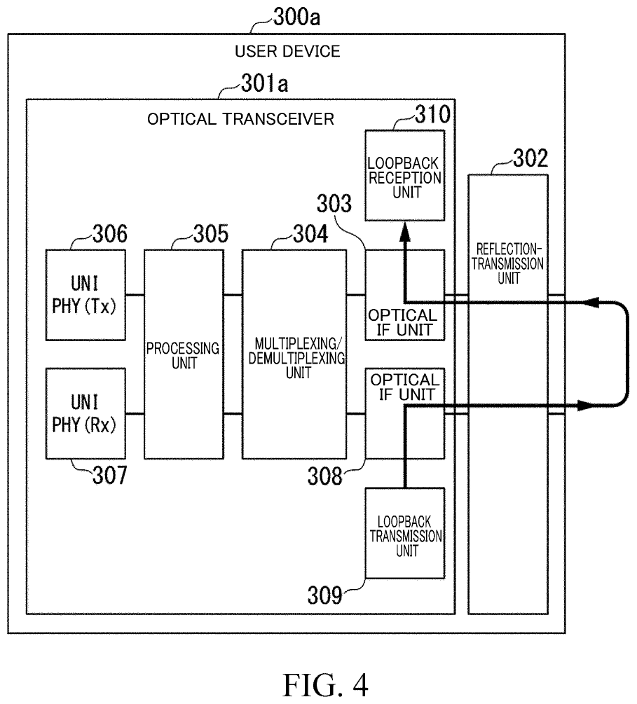

FIG. 4 illustrates a first configuration example of a user device 300a in the modified example of the first embodiment. The user device 300a includes an optical transceiver 301a and the reflection-transmission unit 302. The user device 300a includes the reflection-transmission unit 302 on the side of the user device 300a that is closer to the APN (Ph-GW). The user device 300a may include the reflection-transmission unit 302 in the optical transceiver 301. The user device 300a may execute any of (A1) to (A3) illustrated below.
(A1) When a loopback test is not being performed, the optical interface unit 308 converts an electrical signal into an optical signal and outputs the optical signal to the reflection-transmission unit 302. The reflection-transmission unit 302 transmits the optical signal without reflecting it, and outputs it to the optical interface unit 303.
(A2) When performing a loopback test of the optical interface unit, the optical interface unit 308 converts an internal test signal (electrical signal) from the processing unit 305 into an optical signal. The reflection-transmission unit 302 loops back the optical signal to the optical interface unit 303. The optical interface unit 303 converts the optical signal into an electrical signal. The optical interface unit 303 loops back the electrical signal to the processing unit 305. The processing unit 305 determines the normality of an internal path of the user device 300a based on the optical signal looped back by the reflection-transmission unit 302. In this manner, the user device 300a converts the internal test signal into the optical signal, and then loops back the optical signal within the user device 300a. An internal test that loops back between the UNI_PHY (Tx) 306 and the UNI_PHY (Rx) 307 may be performed. Similarly to loopback of optical signals between the UNI_PHY (Tx) 306 and the UNI_PHY (Rx) 307, the internal test may be performed in which signals are looped back between the optical interface unit 308 and the optical interface unit 303 without going through reflection-transmission unit 302. In this case, the reflection-transmission unit 302 does not have to loop back the optical signal from the user device even if it loops back the optical signal from the network. However, in a case where the signal is looped back between the optical interface unit 303 and the optical interface unit 308 without going through the reflection-transmission unit 302, since a signal that is not the optical signal is looped back, the normality of the optical transmitter and optical receiver cannot be determined compared to the case where the signal passes through the reflection-transmission unit 302. In the operation mode for loopback test, the reflection-transmission unit 302 reflects the optical signal, and in another mode, the reflection-transmission unit 302 may perform other processing. Both the operation modes for loopback test and another mode may be executed in parallel.
(A3) When performing a path loopback test, the loopback transmission unit 309 outputs an electrical signal to the optical interface unit 308. The optical interface unit 308 converts the electrical signal into an optical signal. The optical reflection-transmission unit 302 does not reflect the optical signal but transmits the light to the network side. The transmitted light is looped back via the path to an end point of a section for which the normality is determined, or beyond that end point. The optical reflection-transmission unit 302 transmits the looped-back light to the optical interface unit 303 as an optical signal. An arrow shown in FIG. 4 represents a path of the optical signal. The optical interface unit 303 converts the optical signal into an electrical signal. The loopback reception unit 301 receives the electrical signal. A user device that executes only “(A1)” (normal communication) and “(A3)” (processing of loopback OE conversion on the end point side) does not need to include the reflection-transmission unit 302. A device opposite to the user device that executes only “(A1)” and “(A3)” performs “(A1)” and the “(A2)” (looping back as light). This corresponds to “(A4)” below.

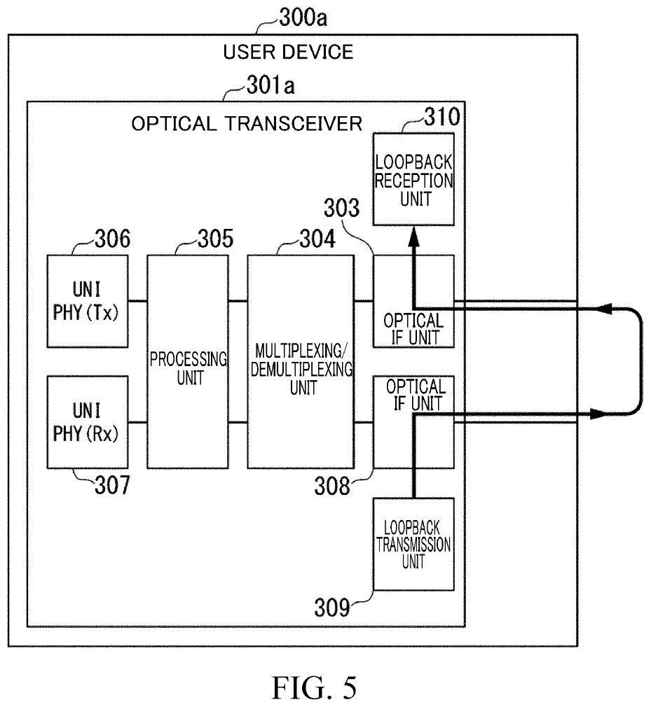

FIG. 5 illustrates a second configuration example of the user device 300a in the modified example of the first embodiment. In FIG. 5, the user device 300a may include the reflection-transmission unit 302. The user device 300a may execute (A4) or (A5) illustrated below.
(A4) The loopback transmission unit 309 outputs an electrical signal to the optical interface unit 308. The optical interface unit 308 converts the electrical signal into an optical signal. The opposing device (Ph-GW 100 or user device 300) loops back the optical signal. A loopback arrow shown in FIG. 5 represents the loopback of the optical signal. The optical interface unit 303 converts the optical signal into an electrical signal. The optical interface unit 303 outputs the electrical signal to the loopback reception unit 310.
(A5) The processing unit 305 outputs the electrical signal to the optical interface unit 308. The optical interface unit 308 converts the electrical signal into an optical signal. The opposing device (Ph-GW 100 or user device 300) loops back the optical signal. The optical interface unit 303 converts the optical signal into an electrical signal. The optical interface unit 303 outputs the electric signal to the processing unit 305. The operation when loopback is not performed and the operation during the internal test are similar to those shown in FIG. 4.

The optical transceiver 301a includes an optical interface unit 303 (optical IF unit), a multiplexing/demultiplexing unit 304, a processing unit 305, a UNI_PHY (Tx) 306, a UNI_PHY (Rx) 307, an optical interface unit 308 (optical IF unit), a loopback transmission unit 309, and a loopback reception unit 310.

The loopback transmission unit 309 transmits an optical signal used as a loopback signal to the Ph-GW 100 or the user device 300. The Ph-GW 100 or the user device 300 loops back the optical signal to the user device 300a as light. The loopback reception unit 310 receives, for example, the optical signal looped back by the Ph-GW 100. The loopback reception unit 310 executes processing for determining signal path normality using a method similar to the signal path normality determination by the access network management control unit 103, for example.

A light source for the optical signal used as the loopback signal may be separate from a light source for the main signal, or there may be a plurality of light sources. The light source for the optical signal used as the loopback signal may be shared as the light source for the optical signal used as the main signal. In a case where the light source is different from the light source for the main signal, the loopback reception unit 310 may receive at least a signal of such a light source and may receive the main signal. In a case where the light source for the main signal is shared, the loopback reception unit 310 receives a signal of such a light source.

As described above, the loopback transmission unit 309 transmits the optical signal to the Ph-GW 100 or the user device 300. The Ph-GW 100 or the user device 300 loops back the optical signal to the user device 300a as light. The loopback reception unit 310 acquires the optical signal looped back by the Ph-GW 100 or the user device 300. The loopback reception unit 310 executes processing for signal path normality determination.

This makes it possible to determine the normality of the optical signal path without performing OEO conversion at the loopback point of the optical signal.

### Modified Example of First Embodiment

FIG. 6 is a diagram illustrating a first configuration example of a photonic gateway (opposing device) in a modified example of the first embodiment. The Ph-GW 100 includes the reflection-transmission unit 302 upstream of the optical cross-connect unit 101. The reflection-transmission unit 302 loops back the optical signal. The opposing user device 300 may include the reflection-transmission unit 302. In the case of a dual-fiber bidirectional mode, an optical coupler/splitter is arranged upstream of the reflection-transmission unit 302, and the dual-fiber optical fibers are connected to the optical coupler/splitter.

FIG. 7 is a diagram illustrating a second configuration example of a photonic gateway (opposing device) in the modified example of the first embodiment. The Ph-GW 100 includes the reflection-transmission unit 302 downstream of the optical cross-connect unit 101. The reflection-transmission unit 302 loops back the optical signal. The opposing user device 300 may include the reflection-transmission unit 302. In the case of a dual-fiber bidirectional mode, an optical coupler/splitter is arranged upstream of the reflection-transmission unit 302, and either upstream or downstream of the optical cross-connect unit, and the dual-fiber optical fibers are connected to the optical coupler/splitter.

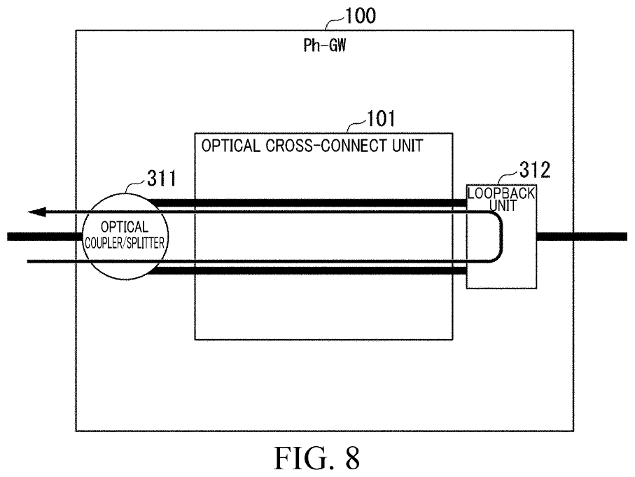

FIG. 8 is a diagram illustrating a third configuration example of a photonic gateway (opposing device) in the modified example of the first embodiment. The Ph-GW 100 includes an optical coupler/splitter 311 upstream of the optical cross-connect unit 101. The Ph-GW 100 includes a loopback unit 312 downstream of the optical cross-connect unit 101. The optical coupler/splitter 311 multiplexes or splits an optical signal. The loopback unit 312 loops back the optical signal. The opposing user device 300 may include the optical coupler/splitter 311 and the loopback unit 312. Furthermore, in the case of a single-core bidirectional mode, the optical coupler/splitter 311 is required, but in the case of a dual-fiber bidirectional mode, the optical coupler/splitter 311 is not required.

### Second Embodiment

In the second embodiment, main differences from the first embodiment are that a loopback device (gatekeeper) that determines the path normality (section monitoring) is provided at the entrance of a demarcation point (UNI), and the loopback device loops back an optical signal in response to a loopback instruction from the Ph-GW. In the second embodiment, differences from the first embodiment will be mainly described.

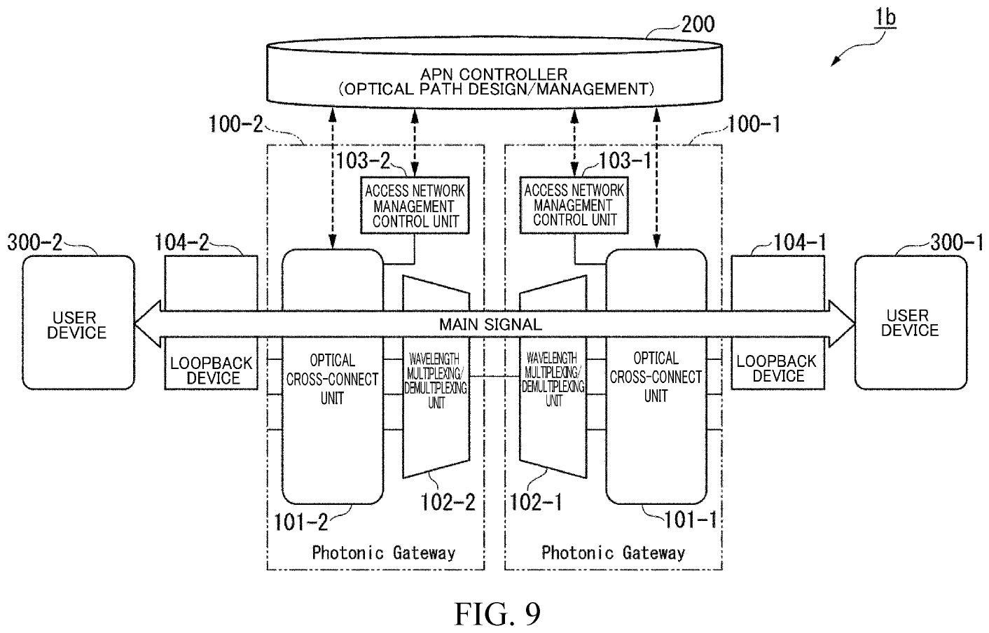

FIG. 9 is a diagram illustrating a configuration example of a communication system 1b in a second embodiment. The communication system 1b is a communication system that communicates using a communication network such as an all-photonics network (APN). The communication system 1b determines the normality of an optical signal path at a loopback point of an optical signal without performing OEO conversion.

The communication system 1b includes a Ph-GW 100-1, a Ph-GW 100-2, a loopback device 104-1 (gatekeeper), a loopback device 104-2 (gatekeeper), an APN controller 200, a user device 300-1, and a user device 300-2. The optical cross-connect unit 101 includes a plurality of input/output ports (not shown).

When a loopback signal is transmitted and received by the access network management control unit 103-2 of the Ph-GW 100-2, for example, the normality of a path connecting the access network management control unit 103-2, the optical cross-connect unit 101-2, the loopback device 104-2, the optical cross-connect unit 101-2 and the access network management control unit 103-2 is determined.

When the loopback signal is transmitted and received by the access network management control unit 103-2 of the Ph-GW 100-2, for example, the normality of the following paths may be determined: a transmission path connecting the access network management control unit 103-2, the optical cross-connect unit 101-2, a loopback unit (not shown) or a reflection-transmission unit (not shown) on the left side of the optical cross-connect unit 101-2, the optical cross-connect unit 101-2, the wavelength multiplexing/demultiplexing unit 102-2, and the gateway; and a transmission path connecting the wavelength multiplexing/demultiplexing unit 102-1, the optical cross-connect unit 101-1, the loopback device 104-1, the optical cross-connect unit 101-1, the wavelength multiplexing/demultiplexing unit 102-1, the wavelength multiplexing/demultiplexing unit 102-2, the loopback unit (not shown) or the reflection-transmission unit (not shown) on the left side of the optical cross-connect unit 101-2, the wavelength multiplexing/demultiplexing unit 102-2, and the access network management control unit 103-2.

When the loopback signal is transmitted and received by the access network management control unit 103-2 of the Ph-GW 100-2, for example, the normality of the following paths may be determined: a transmission path connecting the access network management control unit 103-2, the optical cross-connect unit 101-2, the loopback unit (not shown) or the reflection-transmission unit (not shown) on the left side of the optical cross-connect unit 101-2, the optical cross-connect unit 101-2, the wavelength multiplexing/demultiplexing unit 102-2, and the gateway; a transmission path connecting the wavelength multiplexing/demultiplexing unit 102-1, the optical cross-connect unit 101-1, a loopback unit (not shown) or a reflection-transmission unit (not shown) on the right side of the optical cross-connect unit 101-1, the optical cross-connect unit 101-1, the wavelength multiplexing/demultiplexing unit 102-1, and the gateway; and a path connecting the wavelength multiplexing/demultiplexing unit 102-2, the optical cross-connect unit 101-2, the loopback unit (not shown) or the reflection-transmission unit (not shown) on the left side of the optical cross-connect unit 101-2, the optical cross-connect unit 101-2, and the access network management control unit 103-2.

When a loopback signal is transmitted and received by the access network management control unit 103-1 of the Ph-GW 100-1, for example, the normality of a path connecting the access network management control unit 103-1, the optical cross-connect unit 101-1, the loopback device 104-1, the optical cross-connect unit 101-1 and the access network management control unit 103-1 is determined.

When the loopback signal is transmitted and received by the access network management control unit 103-1 of the Ph-GW 100-1, for example, the normality of the following paths may be determined: a transmission path connecting the access network management control unit 103-1, the optical cross-connect unit 101-1, a loopback unit (not shown) or a reflection-transmission unit (not shown) on the left side of the optical cross-connect unit 101-1, the optical cross-connect unit 101-1, the wavelength multiplexing/demultiplexing unit 102-1, and the gateway; and a transmission path connecting the wavelength multiplexing/demultiplexing unit 102-2, the optical cross-connect unit 101-2, the loopback device 104-2, the optical cross-connect unit 101-2, the wavelength multiplexing/demultiplexing unit 102-2, the wavelength multiplexing/demultiplexing unit 102-1, the loopback unit (not shown) or the reflection-transmission unit (not shown) on the left side of the optical cross-connect unit 101-1, the wavelength multiplexing/demultiplexing unit 102-1, and the access network management control unit 103-1.

When the loopback signal is transmitted and received by the access network management control unit 103-1 of the Ph-GW 100-1, for example, the normality of the following paths may be determined: a transmission path connecting the access network management control unit 103-1, the optical cross-connect unit 101-1, the loopback unit (not shown) or the reflection-transmission unit (not shown) on the left side of the optical cross-connect unit 101-1, the optical cross-connect unit 101-1, the wavelength multiplexing/demultiplexing unit 102-1, and the gateway; a transmission path connecting the wavelength multiplexing/demultiplexing unit 102-2, the optical cross-connect unit 101-2, a loopback unit (not shown) or a reflection-transmission unit (not shown) on the right side of the optical cross-connect unit 101-2, the optical cross-connect unit 101-2, the wavelength multiplexing/demultiplexing unit 102-2, and the gateway; and a path connecting the wavelength multiplexing/demultiplexing unit 102-1, the optical cross-connect unit 101-1, the loopback unit (not shown) or the reflection-transmission unit (not shown) on the left side of the optical cross-connect unit 101-1, the optical cross-connect unit 101-1, and the access network management control unit 103-1.

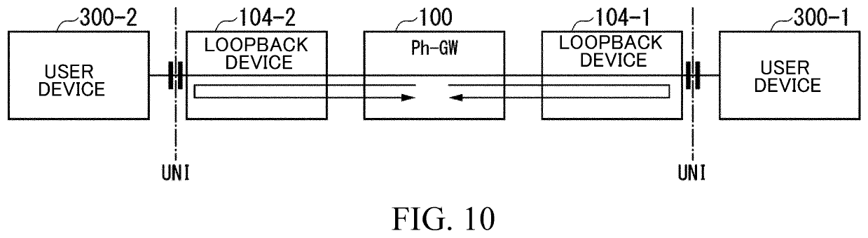

FIG. 10 is a diagram illustrating an example of loopback in the second embodiment. The communication system 1b includes the loopback device 104 at the entrance of the demarcation point (UNI). The loopback device 104 does not perform OEO conversion on the optical signal transmitted from the Ph-GW 100, and loops back the optical signal to the Ph-GW 100 as light. A loopback arrow shown in FIG. 10 represents the loopback of the optical signal. The loopback device 104 switches reflection or transmission of the optical signal according to a loopback instruction from the Ph-GW 100. The loopback device 104 loopback the optical signal as light by reflecting the optical signal. The Ph-GW 100 acquires the optical signal looped back by the loopback device 104. This allows the Ph-GW 100 to determine the normality of the path from the vicinity of the loopback device 104 to the Ph-GW 100 (section monitoring).

The optical cross-connect unit 101 operates under the control of the access network management control unit 103. The optical cross-connect unit 101 instructs the loopback device 104 (gatekeeper) to loop back the optical signal transmitted from the Ph-GW 100 as light, using, for example, a control signal (loopback instruction signal).

The loopback device 104 is a communication device that loops back optical signals. The loopback device 104 loops back an optical signal as light, and transmits it to the optical cross-connect unit 101 of the Ph-GW 100. This corresponds, for example, to the loopback device 104 (loopback point) looping back the optical signal to the optical cross-connect unit 101 without changing any bits in a bit sequence of the received loopback signal. That is, the loopback device 104 is equivalent to performing loopback of all channels. In other words, the loopback device 104 reflects the optical signal transmitted from the Ph-GW 100. In the case of single-core bidirectional communication, the loopback device 104 (transfer device) reflects the optical signal onto single core fiber into which the optical signal has been input.

The loopback device 104 (transfer device) may transfer optical signals. For example, when a looped-back signal is transferred, downstream and upstream core fibers are distinguished and the looped-back signal is transferred. When a downstream signal and an upstream signal are transmitted, the downstream signal on the downstream core fiber is transferred as the upstream signal using the upstream core fiber. In the case of dual-fiber bidirectional communication, the loopback device 104 (transfer device) reflects the optical signal onto single core fiber different from single core fiber into which the optical signal has been input. For example, when the downstream signal arrives at the loopback device on the downstream signal core fiber, the loopback device 104 (transfer device) reflects the input signal as the upstream signal on the upstream signal core fiber (for example, when the loopback device 104 on the user device side loops back the optical signal to the network side). When the upstream signal arrives at the loopback device 104 on the upstream signal core fiber, the loopback device 104 (transfer device) reflects the input signal as the downstream signal on the downstream signal core fiber (for example, when the loopback device 104 on the network device side loops back the optical signal to the user side).

The optical cross-connect unit 101 may use, for example, a control signal to instruct the loopback device 104 (gatekeeper) to rewrite a part of a bit sequence designated in an optical signal transmitted from the Ph-GW 100 or a part of the optical signal and then loop it back (partial loopback). In the partial loopback, the loopback device 104 changes a part of a bit sequence or an optical signal of the designated channel (such as a predetermined time domain or frequency domain), without change a part of a bit sequence or an optical signal of the undesignated channel, and loops back the optical signal to the optical cross-connect unit 101. The loopback device 104 may deliver information regarding the loopback device 104 to the Ph-GW 100 by rewriting a part of the bit sequence designated in the optical signal transmitted from the Ph-GW 100 or the optical signal and then looping it back.

The optical cross-connect unit 101 may use, for example, a control signal to instruct the loopback device 104 (gatekeeper) to rewrite predetermined information in one or more channels selected from among a plurality of channels of the optical signal transmitted from the Ph-GW 100 or a part of the optical signal and then loop it back (logical loopback). The logical loopback is defined, for example, for any layer of the Open Systems Interconnection (OSI) model. The logical loopback is performed according to detailed predetermined maintenance procedures. The loopback device 104 may deliver information regarding the loopback device 104 to the Ph-GW 100 by rewriting predetermined information in one or more channels selected from among a plurality of channels of the optical signal transmitted from the Ph-GW 100 or a part of the optical signal and then looping it back. The information regarding the loopback device 104 is, for example, a bit error rate or a measurement result of signal quality.

The optical signal to be looped back may be an optical signal that is a main signal, an optical signal for operation management and maintenance (for example, an OAM signal), or an optical signal that is a control signal (for example, an AMCC signal). The optical signal to be looped back may be an optical signal that is a client signal of an optical transport network (OTN). The signal to be looped back may be a main signal, a signal for operation management and maintenance (for example, an OAM signal), or a control signal (for example, an AMCC signal). The signal to be looped back may be a client signal of an optical transport network (OTN). When the client signal is looped back, a signal at the time of transmitting the OTN overhead is not reflected, but only an optical signal at the time of transmitting the client signal is reflected.

The optical signal to be looped back does not need to include another wavelength division-multiplexed (WDM) carrier (a different wavelength division-multiplexed optical signal). The optical signal to be looped back does not need to include a signal superimposed using frequency division multiplexing (FDM) like an AMCC signal. The access network management control unit 103 executes signal path normality determination processing regarding paths and communication functions. That is, when the main signal and the control signal are different optical signals (separate carriers) from different light sources, the control signal does not need to be superimposed on the optical signal that transmits the main signal by, for example, AMCC. Further, when the target of loopback is one of them, only the corresponding optical signal may be looped back, or the optical signal that is not the target of loopback may also be looped back.

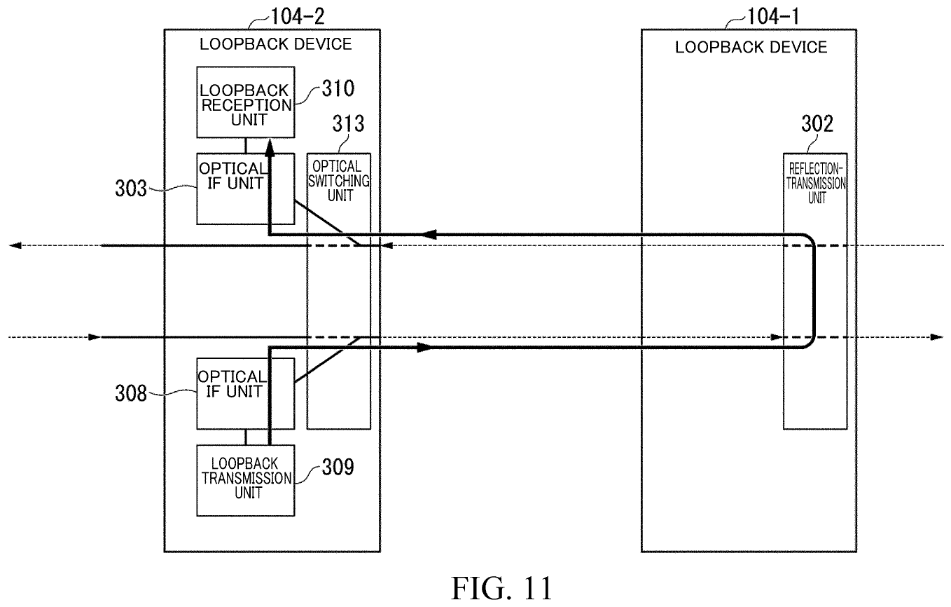

FIG. 11 is a diagram illustrating a second example of loopback in the second embodiment. The loopback devices 104 may perform a loopback test with each other. The loopback device 104-1 includes the reflection-transmission unit 302. The loopback device 104-2 includes an optical interface unit 303, an optical interface unit 308, a loopback transmission unit 309, a loopback reception unit 310, and an optical switching unit 313. A thin broken line represents an optical signal in a case where the optical signal is not looped back by the reflection-transmission unit 302 (during normal communication).

The optical switching unit 313 outputs the optical signal output from the optical interface unit 308 to the reflection-transmission unit 302. The reflection-transmission unit 302 loops back the optical signal. A loopback arrow shown in FIG. 11 represents the loopback of the optical signal. The optical switching unit 313 outputs the looped-back optical signal to the optical interface unit 303.

The loopback device 104 may transmit and receive the optical signal, and the Ph-GW 100 may loop back the optical signal. In FIG. 11, the loopback device 104 is shown in a form suitable for dual-fiber bidirectional transmission using different cores for each transmission direction. However, paths for inputting and outputting optical signals to and from the loopback device 104 may be a single core in accordance with single-core bidirectional communication in which both transmission directions are transmitted using a single core fiber.

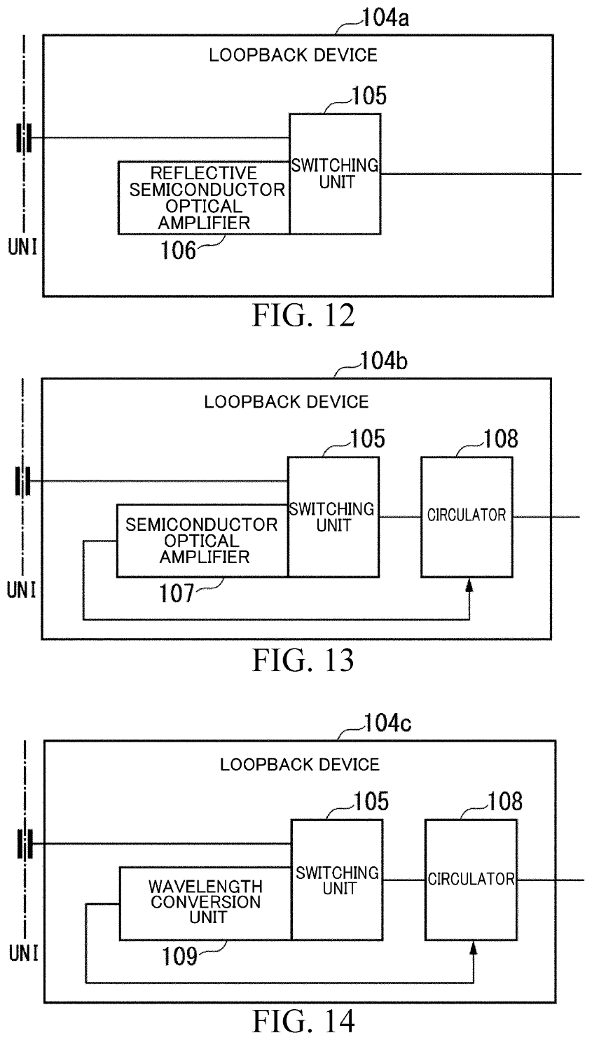

FIG. 12 is a diagram illustrating a first configuration example of a loopback device 104a in the second embodiment. The loopback device 104a may perform amplification and modulation. The loopback device 104a corresponds to the loopback device 104 illustrated in FIG. 10. The loopback device 104a includes a switching unit 105 and a reflective semiconductor optical amplifier 106.

A main configuration of the reflective semiconductor optical amplifier 106 is a semiconductor optical amplifier (SOA). In a case where the optical signal is amplified, the loopback device 104a may include an amplifier other than the semiconductor optical amplifier as long as it is possible to amplify the optical signal. In a case where the optical signal is modulated, the loopback device 104a may include an amplifier other than the semiconductor optical amplifier as long as it is possible to modulate the optical signal. For example, if the optical signal is modulated, the loopback device 104a may include an electro-absorption modulator.

The switching unit 105 switches output destination of the optical signal transmitted from the Ph-GW 100 to either the user network interface (UNI) or the reflective semiconductor optical amplifier 106 based on a control signal, for example. When the output destination of the optical signal is a user network interface, the optical signal is received by the user device 300. When the output destination of the optical signal is the reflective semiconductor optical amplifier 106, the reflective semiconductor optical amplifier 106 loops back the amplified optical signal to the Ph-GW 100 via the switching unit 105.

The switching unit 105 or the reflective semiconductor optical amplifier 106 may perform partial loopback or logical loopback. The switching unit 105 or the reflective semiconductor optical amplifier 106 may deliver information regarding the loopback device 104 to the Ph-GW 100 by partial loopback or logical loopback. Although the loopback device 104a is shown in FIG. 12 in accordance with the single-core bidirectional communication, in the case of dual-fiber bidirectional communication, the loopback device 104a loops back a downstream signal from single core fiber that transmits the downstream signal to single core fiber that transmits an upstream signal via the amplifier during loopback. In the case of dual-fiber bidirectional communication, the loopback device 104a transmits the downstream signal from single core fiber that transmits the downstream signal from the network side to single core fiber that transmits the downstream signal from the user side, except during loopback, without changing. The loopback device 104a may transmit the upstream signal from the core fiber that transmits the upstream signal from the user side to the core fiber that transmits the upstream signal from the network side, without changing. The subsequent processing is the same as above.

FIG. 13 is a diagram illustrating a second configuration example of a loopback device 104b in the second embodiment. The loopback device 104b corresponds to the loopback device 104 illustrated in FIG. 10. The loopback device 104b includes a switching unit 105, a semiconductor optical amplifier 107, and a circulator 108.

The circulator 108 outputs the optical signal transmitted from the Ph-GW 100 to switching unit 105. The circulator 108 outputs the optical signal transmitted from the semiconductor optical amplifier 107 to the Ph-GW 100. The switching unit 105 switches output destination of the optical signal transmitted from the circulator 108 to either the user network interface (UNI) or the semiconductor optical amplifier 107 based on a control signal, for example. When the output destination of the optical signal is a user network interface, the optical signal is received by the user device 300. When the output destination of the optical signal is the semiconductor optical amplifier 107, the semiconductor optical amplifier 107 loops back the amplified optical signal to the Ph-GW 100 via the circulator 108.

The switching unit 105 or the semiconductor optical amplifier 107 may perform partial loopback or logical loopback. The switching unit 105 or the semiconductor optical amplifier 107 may deliver information regarding the loopback device 104b to the Ph-GW 100 by partial loopback or logical loopback. Although the loopback device 104b is shown in FIG. 13 in accordance with the single-core bidirectional communication, in the case of dual-fiber bidirectional communication, the loopback device 104b loops back a downstream signal from single core fiber that transmits the downstream signal to single core fiber that transmits an upstream signal via the amplifier during loopback. In the case of dual-fiber bidirectional communication, the loopback device 104b transmits the downstream signal from single core fiber that transmits the downstream signal from the network side to single core fiber that transmits the downstream signal from the user side, except during loopback, without changing. The loopback device 104b may transmit the upstream signal from the core fiber that transmits the upstream signal from the user side to the core fiber that transmits the upstream signal from the network side, without changing. The subsequent processing is the same as above.

FIG. 14 is a diagram illustrating a third configuration example of a loopback device 104c in the second embodiment. The loopback device 104c corresponds to the loopback device 104 illustrated in FIG. 10. The loopback device 104c includes a switching unit 105, a circulator 108, and a wavelength conversion unit 109.

The circulator 108 outputs the optical signal transmitted from the Ph-GW 100 to switching unit 105. The circulator 108 outputs the optical signal transmitted from the wavelength conversion unit 109 to the Ph-GW 100.

The switching unit 105 switches output destination of the optical signal transmitted from the circulator 108 to either the user network interface (UNI) or the wavelength conversion unit 109 based on a control signal, for example. When the output destination of the optical signal is a user network interface, an optical signal of a first wavelength is received by the user device 300. When the output destination of the optical signal is the wavelength conversion unit 109, the wavelength conversion unit 109 loops back an optical signal of a second wavelength to the Ph-GW 100 via the circulator 108. The wavelength conversion unit 109 converts the wavelength of the optical signal that is looped back to the Ph-GW 100 into a second wavelength that is assigned to the optical signal that is transmitted in a direction from the loopback device 104c to the Ph-GW 100.

The switching unit 105 or the wavelength conversion unit 109 may perform partial loopback or logical loopback. The switching unit 105 or the wavelength conversion unit 109 may deliver information regarding the loopback device 104 to the Ph-GW 100 by partial loopback or logical loopback. Although the loopback device 104c is shown in FIG. 14 in accordance with the single-core bidirectional communication, in the case of dual-fiber bidirectional communication, the loopback device 104c loops back a downstream signal from single core fiber that transmits the downstream signal to single core fiber that transmits an upstream signal via the amplifier during loopback. In the case of dual-fiber bidirectional communication, the loopback device 104c transmits the downstream signal from single core fiber that transmits the downstream signal from the network side to single core fiber that transmits the downstream signal from the user side, except during loopback, without changing. The loopback device 104c may transmit the upstream signal from the core fiber that transmits the upstream signal from the user side to the core fiber that transmits the upstream signal from the network side, without changing. The subsequent processing is the same as above.

As described above, the Ph-GW 100 may determine that the path of the optical signal is normal in a case where an attenuation amount of the acquired optical signal is a predetermined attenuation amount. The Ph-GW 100 may determine that the path of the optical signal is normal in a case where a time length during which the optical signal is looped back is equal to a predetermined time length. The Ph-GW 100 may determine that the path of the optical signal is normal in a case where an intensity of the acquired optical signal varies at a timing corresponding to the loopback instruction. The Ph-GW 100 may determine that the path of the optical signal is normal in a case where a polarization rotation amount of the acquired optical signal is a predetermined rotation amount. The Ph-GW 100 may determine that the path of the optical signal is normal in a case where an intensity of the acquired optical signal varies for each wavelength according to a reflectance per wavelength of the optical signal.

This makes it possible to determine the normality of the optical signal path without performing OEO conversion at the loopback point of the optical signal.

### Modified Example of Second Embodiment

Main differences from the second embodiment in a modified example of the second embodiment include that a first loopback device transmits an optical signal to a second loopback device, and the second loopback device loops back the optical signal as light. The modified example of the second embodiment will be described focusing on differences from the second embodiment.

FIG. 15 is a diagram illustrating a configuration example of a loopback device 104d in a modified example of the second embodiment. The loopback device 104d corresponds to the loopback device 104 illustrated in FIG. 10. The loopback device 104d includes a loopback transmission unit 110 and a loopback reception unit 111.

The loopback transmission unit 110 of a loopback device 104d-2 transmits an optical signal used as a loopback signal to a loopback device 104d-1. The loopback device 104d-1 loops back the optical signal to the loopback device 104d-2 as light. A loopback arrow shown in FIG. 15 represents the loopback of the optical signal. The loopback reception unit 111 of the loopback device 104d-2 receives (acquires) the optical signal looped back by the loopback device 104d-1. The loopback reception unit 111 of the loopback device 104d-2 executes processing for determining signal path normality using a method similar to the signal path normality determination by the access network management control unit 103, for example. Although the loopback device 104d is shown in FIG. 15 in accordance with the single-core bidirectional communication, in the case of dual-fiber bidirectional communication, the loopback device 104d loops back a downstream signal from single core fiber that transmits the downstream signal to single core fiber that transmits an upstream signal via the amplifier during loopback. In the case of dual-fiber bidirectional communication, the loopback device 104d transmits the downstream signal from single core fiber that transmits the downstream signal from the network side to single core fiber that transmits the downstream signal from the user side, except during loopback, without changing. The loopback device 104d may transmit the upstream signal from the core fiber that transmits the upstream signal from the user side to the core fiber that transmits the upstream signal from the network side, without changing. The subsequent processing is the same as above.

A light source for the optical signal used as the loopback signal may be a separate light source, or may be a plurality of light sources. The light source for the optical signal used as the loopback signal may be shared as the light source for the optical signal used as the main signal. The loopback reception unit 111 may receive the main signal. As for the optical signal that is the main signal, the transmitted optical signal may be used as it is, or the transmitted optical signal may be modulated and amplified before being used.

As described above, the loopback device 104d-2 (first loopback device) transmits the optical signal to the loopback device 104d-1 (second loopback device). The loopback device 104d-2 receives (acquires) the optical signal looped back by the loopback device 104d-1. The loopback device 104d-2 executes processing for signal path normality determination.

Therefore, even in a case where the main signal is not transmitting, it is possible to determine the normality of the optical signal path without performing OEO conversion at the loopback point of the optical signal.

### Hardware Configuration Example

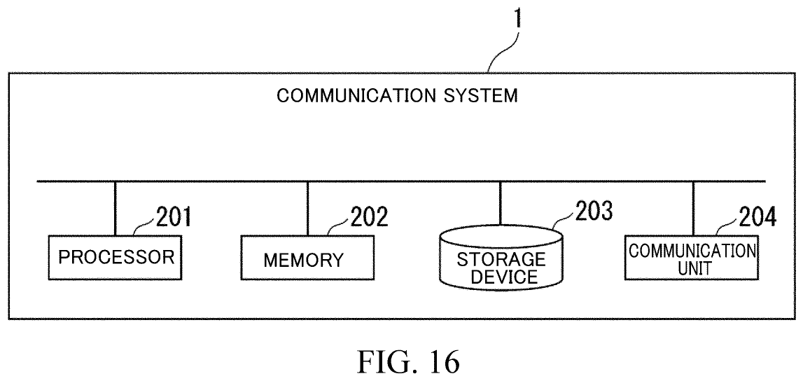

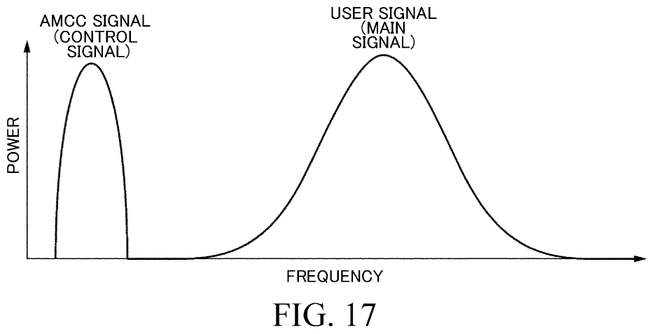

FIG. 16 is a diagram illustrating a hardware configuration example of the communication system 1 according to an embodiment. Some or all of the functional units of the communication system 1 are implemented as software by a processor 201 such as a central processing unit (CPU) executing a program stored in the storage device 203 that has a nonvolatile recording medium (non-transitory recording medium) and a memory 202. The program may be recorded on a non-transitory computer-readable recording medium. The non-transitory computer-readable recording medium is, for example, a portable medium such as a flexible disk, a magneto-optical disk, a read only memory (ROM) or a compact disc read only memory (CD-ROM); or a non-transitory recording medium such as a storage device, for example, a hard disk built in a computer system. A communication unit 204 executes the predetermined communication processing. The communication unit 204 may acquire data of an optical signal transmitted through the optical fiber (e.g. main signal data or wavelength data) and a program.

A part or all of the functional units of the communication system 1 may be implemented by using hardware including an electronic circuit or circuitry using, for example, a large-scale integrated circuit (LSI), an application specific integrated circuit (ASIC), a programmable logic device (PLD), or a field programmable gate array (FPGA).

Although the embodiments of the present invention have been described in detail with reference to the drawings, a specific configuration is not limited to these embodiments, and the present invention encompasses designs without departing form the gist of the present invention.

### Industrial Applicability

The present invention is applicable to a communication system that communicates using a communication network such as an all-photonics network (APN).

### Reference Signs List

1, 1a, 1b Communication system
100 Ph-GW
101 Optical cross-connect unit
102 Wavelength multiplexing/demultiplexing unit
103 Access network management control unit
104, 104a, 104b, 104c Loopback device
105 Switching unit
106 Reflective semiconductor optical amplifier
107 Semiconductor optical amplifier
108 Circulator
109 Wavelength conversion unit
110 Loopback transmission unit
111 Loopback reception unit
200 APN controller
201 Processor
202 Memory
203 Storage device
204 Communication unit
300, 300a User device
301 Optical transceiver
302 Reflection-transmission unit
303 Optical interface unit
304 Multiplexing/demultiplexing unit
305 Processing unit
306 UNI_PHY (Tx)
307 UNI_PHY (Rx)
308 Optical interface unit
309 Loopback transmission unit
310 Loopback reception unit
311 Optical coupler/splitter
312 Loopback unit
313 Optical switching unit

1. A communication system, comprising:
an instruction device that transmits a loopback instruction for an optical signal;
a transceiver device that transmits the optical signal; and
a loopback device that loops back the transmitted optical signal to the transceiver device as light based on the loopback instruction,
wherein the transceiver device acquires the looped-back optical signal and determines whether a path of the optical signal is normal based on the acquired optical signal.

2. The communication system according to claim 1, wherein the transceiver device determines that the path of the optical signal is normal in a case where an attenuation amount of the acquired optical signal is a predetermined attenuation amount.

3. The communication system according to claim 1, wherein the transceiver device determines that the path of the optical signal is normal in a case where a time length during which the optical signal is looped back is equal to a predetermined time length.

4. The communication system according to claim 1, wherein the transceiver device determines that the path of the optical signal is normal in a case where an intensity of the acquired optical signal varies at a timing corresponding to the loopback instruction.

5. The communication system according to claim 1, wherein the transceiver device determines that the path of the optical signal is normal in a case where a polarization rotation amount of the acquired optical signal is a predetermined polarization rotation amount.

6. The communication system according to claim 1, wherein the transceiver device determines that the path of the optical signal is normal in a case where an intensity of the acquired optical signal varies for each wavelength according to a reflectance per wavelength of the optical signal.

7. A normality determination method executed by a communication system, comprising:
transmitting a loopback instruction for an optical signal;
transmitting the optical signal;
looping back the transmitted optical signal to a transceiver device as light based on the loopback instruction;
acquiring the looped-back optical signal; and
determining whether a path of the optical signal is normal based on the acquired optical signal.
